(19) United States
(12) Patent Application Publication
(10) Pub. No.: US 2024/0136663 A1
(43) Pub. Date: Apr. 25, 2024

(54) IMPROVED LEAD ACID BATTERY SEPARATORS HAVING IMPROVED COMPRESSIBILITY; BATTERIES, SYSTEMS, AND RELATED METHODS INCORPORATING THE SAME

(71) Applicant: Daramic, LLC, Charlotte, NC (US)

(72) Inventor: Miller Eric H., Philpot, KY (US)

(21) Appl. No.: 17/768,859

(22) PCT Filed: Oct. 26, 2020
(86) PCT No.: PCT/US2020/057453

§ 371 Date: Apr. 13, 2022

Related U.S. Application Data
(60) Provisional application No. 62/927,183, filed on Oct. 29, 2019.

(51) Int. Cl. H01M 50/463; H01M 10/14; H01M 50/489

(52) U.S. Cl. CPC H01M 50/463; H01M 10/14; H01M 50/489; H01M 2220/10; H01M 2220/20

(57) ABSTRACT

A compressible battery separator is provided with capabilities to accommodate varying spacing between electrodes in a lead acid battery. Battery separators, cells, batteries, systems, and methods of manufacture and methods of use are disclosed herein.

### CROSS-REFERENCE TO RELATED APPLICATIONS

This application is a 371 U.S. Application claiming the benefit of PCT Application No. PCT/US2020/057453, filed on Oct. 27, 2020, which claims priority to U.S. Provisional Application No. 62/927,183, filed Oct. 29, 2019, all of which are hereby fully incorporated by reference herein.

### FIELD

The present disclosure is directed to novel or improved separators for a variety of lead acid batteries and/or systems. In addition, exemplary embodiments disclosed herein are directed to novel or improved battery separators, battery cells incorporating the same, batteries incorporating the same, systems incorporating the same, and/or methods of manufacturing and/or of using the same, and/or the like, and/or combinations thereof.

### BACKGROUND

An exemplary lead acid battery has a positive terminal and a negative terminal. Within the battery is an array of alternating positive electrodes and negative electrodes with separators interleaved between each electrode. Alternatively, either the positive or the negative electrodes may be enveloped within a separator envelope, pocket, sleeve, or the like. The positive electrodes are in electrical communication with the positive terminal, and the negative electrodes are in electrical communication with the negative terminal. The positive electrodes have a grid of lead dioxide (PbO₂) that is typically doped with a positive active material (“PAM”). The negative electrodes have a grid of lead (Pb) that is typically doped with a negative active material (“NAM”). Both of the PAM and NAM contribute to increasing the functionality of the electrodes. The positive and negative grids may be provided as alloys having at least one of antimony, calcium, tin, selenium, and/or the like, and/or a combination thereof.

The positive electrodes, negative electrodes, and separators are substantially submerged within an aqueous electrolyte solution. The electrolyte may be, for example, a solution of sulfuric acid (H₂SO₄) and water (H₂O). The electrolyte solution may have, for example, a specific gravity of approximately 1.28, with a range of approximately 1.215 to 1.300.

The purpose of the separator is to separate and insulate the electrodes from electrical conduction with one another, which would short the battery, yet maintain ionic conduction between the electrodes via the electrolyte, which is required for the electrochemical reaction of the battery. Therefore, the separator must be electrically non-conductive, yet porous enough to allow ionic conduction. If the separator is too porous or has pores that are too large, then dendrites are likely to form large enough to bridge the gap between the electrodes and short the battery. Extremely large pores may allow direct physical contact between the electrodes.

Some lead acid battery manufacturing processes are difficult to control, resulting in varied spacing between electrodes. Furthermore, some mobility applications can cause the electrodes to vibrate and change spacing. The present state of the art fails to address or solve these needs and concerns.

As discussed, there remains a need to provide a separator with a variable thickness to accommodate variable spacing between electrodes. As of this application, the inventors know of no battery separator that is capable of providing a variable thickness that can accommodate varying and/or changing electrode spacing. Accordingly, the present invention aims to meet at least these and other heretofore unmet needs.

### SUMMARY

For at least certain applications or batteries, the details of one or more exemplary embodiments, aspects, or objects of the present invention at least provide for battery separators having a variable overall thickness, such as an overall thickness that varies as a function of pressure applied to the separator. Other features, objects, and advantages of the present invention provide for reduced battery failure, improved battery cycle life, and/or improved performance. More particularly, there remains a need to provide a separator capable of adapting to varying electrode spacing, during at least one of the battery's production and/or in use after its manufacture.

The details of one or more exemplary embodiments, aspects, or objects, are in the detailed description and claims set forth hereinafter. Other features, objects, and advantages will be apparent from the detailed description and claims set forth hereinafter. In accordance with one or more select embodiments, aspects, or objects, the present disclosure or invention at least addresses the problems, issues, or needs enumerated herein, and in some cases provides a solution that surprisingly and unexpectedly exceeds needs and expectations.

In accordance with at least certain exemplary embodiments, objects, or aspects, the present disclosure or invention may provide novel or improved separators, cells, batteries, systems, methods of manufacture, use, and/or applications of such novel or improved separators, cells, batteries, and/or systems that overcome at least the aforementioned problems. For example, at least certain exemplary embodiments, objects, or aspects provide batteries with separators that are adaptable to electrodes with varied spacing therebetween, and by providing batteries with separators having variable thicknesses.

In accordance with at least selected exemplary embodiments, aspects, or objects, the present disclosure or invention provides a separator whose components and physical attributes and features synergistically combine to address, in surprising and unexpected ways, previously unmet needs in the lead acid battery industry with an improved battery separator. In certain preferred exemplary embodiments, the present disclosure or invention provides a battery using a separator as described herein to address, in surprising and unexpected ways, previously unmet needs in the lead acid battery industry with an improved lead acid battery separator. In certain preferred exemplary embodiments, the present disclosure or invention provides a system using a battery as described herein to address, in surprising and unexpected ways, previously unmet needs in the lead acid battery industry with an improved system utilizing an inventive lead acid battery that utilizes an inventive separator as described herein.

In accordance with at least certain embodiments, the present disclosure or invention is directed to novel or improved separators, cells, batteries, systems, and/or methods of manufacture and/or use and/or applications of such novel separators, cells, batteries, and/or systems. In accordance with at least certain embodiments, the present disclosure or invention is directed to novel or improved battery separators for: lead acid batteries; flooded lead acid batteries; enhanced flooded lead acid batteries (“EFBs”); flat-plate batteries; tubular batteries; deep-cycle batteries; batteries operating in a partial state of charge (“PSoC”); valve regulated lead acid (“VRLA”) batteries; gel batteries; absorptive glass mat (“AGM”) batteries; inverter batteries; stationary batteries; batteries used while in motion; energy storage for electricity generation, such as by steam turbine generators, such as by coal and/or gas fired power plants, and/or nuclear power plants; energy storage for electricity generation by solar power, wind power, hydro-electric power, or other alternate and/or renewable energy sources; general energy storage batteries; uninterruptible power source (“UPS”) batteries; batteries with high cold-cranking ampere (“CCA”) requirements; vehicle batteries, such as starting-lighting-ignition (“SLI”) vehicle batteries, idling-start-stop (“ISS”) vehicle batteries, marine batteries, automobile batteries, truck batteries, motorcycle batteries, all-terrain vehicle batteries, forklift batteries, golf cart (also referred to as golf cars) batteries, hybrid-electric vehicle (“HEV”) batteries, electric vehicle batteries, light electric vehicle batteries, neighborhood electric vehicle (“NEV”) batteries, e-rickshaw batteries, e-trike batteries, e-bike batteries, electric scooter batteries; and/or the like; and/or combinations thereof. In accordance with select embodiments, the present disclosure or invention is directed to battery separators for use in systems or vehicles incorporating the above-mentioned batteries. In accordance with at least certain aspects, the present disclosure or invention is directed to improved methods of making and/or using such improved separators, cells, batteries, systems, and/or the like.

In accordance with a first select embodiment of the present invention, a battery separator is provided with a porous membrane backweb having a first surface, and a second surface on an opposite side from the first surface. The separator is further provided with an array of ribs made up of a first plurality of ribs extending from the first surface, and a second plurality of ribs extending from the second surface. At least a portion of the first array of ribs are not disposed opposite of any ribs from the second plurality of ribs that are disposed on the second surface.

In accordance with some exemplary aspects of the present invention, the array of ribs may or may not be equidistantly spaced apart. In addition, either or both of the first plurality of ribs and the second plurality of ribs may or may not be equidistantly spaced apart. These rib spacings may exist in any combination.

In accordance with at least one aspect of the present invention, the array of ribs may be arranged such that one or more ribs from the first plurality of ribs alternate with one or more ribs from the second plurality of ribs across the width of the separator.

In some aspects, the separator may possess mini cross-ribs disposed on either or both of the separator surfaces. These mini cross-ribs (or negative cross ribs or NCR) may run in a machine direction of the separator or in a cross-machine direction of the separator between the first and second pluralities of ribs. The mini cross-ribs may have a height of approximately 25 μm to approximately 75 μm.

In select embodiments, the first plurality of ribs may be substantially parallel to one another, the second plurality of ribs may be substantially parallel to one another, and/or the first plurality of ribs may be substantially parallel to the second plurality of ribs. The first plurality of ribs and the second plurality of ribs may be substantially parallel to a machine direction of the separator.

In select preferred aspects of the present invention, the first plurality of ribs and/or the second plurality of ribs may be spaced apart at a distance between approximately 4 mm to approximately 18 mm, between approximately 5 mm to approximately 16 mm, or between approximately 6 mm and approximately 14 mm. The spacing may be 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm.

In accordance with certain preferred embodiments of the present invention, the battery separator may have a relaxed state wherein the porous membrane backweb is generally planar and a different compressed state wherein the porous membrane backweb is generally warped.

In accordance with select preferred embodiments, the separator has an overall thickness defined by the distance between a plane formed by tips of the first plurality of ribs, and a plane formed by the tips of the second plurality of ribs. In select embodiments, the overall thickness in a compressed state is at least approximately 500 μm. In select embodiments, the overall thickness in a compressed state is no more than approximately 2.0 mm. In other embodiments, the overall thickness in a relaxed state is no more than approximately 3.0 mm.

In a relaxed state, the overall thickness may be measures as the sum of the porous membrane backweb thickness, the height of the first plurality of ribs, and the height of the second plurality of ribs. In such case, the overall thickness in a relaxed state is no more than approximately 3.0 mm.

In certain exemplary embodiments, the first plurality of ribs have a first rib height of approximately 200 μm to approximately 1.5 mm. In addition, the second plurality of ribs have a second rib height of approximately 200 μm to approximately 1.5 mm.

In some preferred embodiments, the first plurality of ribs have a first rib height, and said second plurality of ribs comprise a second rib height. The first height is equal to approximately 25% to approximately 400% of the second rib height.

Another aspect of the present invention provides the porous membrane backweb with a thickness of between approximately 125 μm to approximately 250 μm.

In yet another aspect of the present invention, the battery separator may have a composition that includes at least one of polymers, thermoplastic polymers, polyvinyl chlorides (“PVCs”), phenolic resins, natural or synthetic rubbers, synthetic wood pulp, lignins, glass fibers, synthetic fibers, cellulosic fibers, and/or combinations thereof. The natural or synthetic rubbers may include one or more of rubber, latex, natural rubber, synthetic rubber, cross-linked or uncross-linked natural or synthetic rubbers, cured or uncured rubbers, crumb or ground rubber, polyisoprenes, methyl rubber, polybutadiene, chloroprene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers, and/or combinations thereof.

In some aspects of the present invention, the battery separator may further possess a filler that is at least one of silica, dry finely divided silica, precipitated silica, amorphous silica, highly friable silica, alumina, talc, fish meal, fish bone meal, barium sulfate (BaSO₄), carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and/or combinations thereof.

In other aspects of the present invention, the battery separator may further possess a coating that is at least one of barium sulfate (BaSO4), zinc, zinc sulfate, carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and/or combinations thereof.

In yet another exemplary aspect of the present invention, one or both of the first plurality of ribs and the second plurality of ribs are at least one of: solid ribs, discrete broken ribs, continuous ribs, discontinuous ribs, angled ribs, linear ribs, longitudinal ribs extending substantially in a machine direction of the porous membrane, lateral ribs extending substantially in a cross-machine direction of the porous membrane, transverse ribs extending substantially in a cross-machine direction of the porous membrane, cross ribs extending substantially in a cross-machine direction of the porous membrane (or negative cross ribs or NCR), discrete teeth or toothed ribs, serrations, serrated ribs, battlements or battlemented ribs, curved or sinusoidal ribs, disposed in a solid or broken zig-zag-like fashion, grooves, channels, textured areas, bumps, pillars, embossments, dimples, porous, non-porous, mini ribs or cross-mini ribs, and combinations thereof. In another aspect, exemplary battery separators may possess negative cross-ribs (NCRs).

In select preferred embodiments of the present invention, a lead acid battery is provided with one or more positive electrode(s), and one or more negative electrode(s), and an embodiment of a battery separator as generally described and claimed herein disposed therebetween.

In certain aspects of the present invention, the lead acid battery may be one of: a flooded lead acid battery; an enhanced flooded lead acid battery (“EFBs”); a flat-plate battery; a tubular battery; a deep-cycle battery; a battery operating in a partial state of charge (“PSoC”); a valve regulated lead acid (“VRLA”) battery; a gel battery; an absorptive glass mat (“AGM”) battery; an inverter battery; a stationary battery; a battery used while in motion; an energy storage battery for electricity generation; an energy storage battery in general; an uninterruptible power source (“UPS”) battery; a battery with high cold-cranking ampere (“CCA”) requirements; a vehicle battery, such as a starting-lighting-ignition (“SLI”) vehicle battery, an idling-start-stop (“ISS”) vehicle battery, a marine battery, an automobile battery, a truck battery, a motorcycle battery, an all-terrain vehicle battery, a forklift battery, a golf cart (also referred to as golf cars) battery, a hybrid-electric vehicle (“HEV”) battery, an electric vehicle battery, a light electric vehicle battery, a neighborhood electric vehicle (“NEV”) battery, an e-rickshaw battery, an e-trike battery, an e-bike battery, an electric scooter battery; and/or the like; and/or combinations thereof.

In certain preferred exemplary embodiments, the present invention may provide a vehicle, device, or system that utilizes a lead acid battery as generally described and claimed herein that utilizes a battery separator as generally described and claimed herein. That vehicle, device, or system may be at least one of the following: electricity generating systems, such as steam turbine generators, such as by coal and/or gas fired power plants, and/or nuclear power plants; electricity generating systems, such as by solar power, wind power, hydro-electric power, or other alternate and/or renewable energy sources; uninterruptible power sources (“UPSs”); watercraft; automobiles; trucks; motorcycles; all-terrain vehicles; forklifts; golf carts (also referred to as golf cars); hybrid-electric vehicles (“HEVs”); electric vehicles; light electric vehicles; neighborhood electric vehicles (“NEVs”); e-rickshaws; e-trikes; e-bikes; electric scooters; and/or the like; and/or combinations thereof.

In addition, a fibrous mat may be provided. The mat may be one of the following: glass fibers, synthetic fibers, silica, at least one performance enhancing additive, latex, natural rubber, synthetic rubber, and combinations thereof, and may be nonwoven, woven, mesh, fleece, net, and combinations thereof.

Furthermore, the battery separator may be provided as a cut-piece, a leaf, a pocket, a sleeve, a wrap, an envelope, and a hybrid envelope with openings at the bottom.

The first plurality of ribs may further be provided so as to enhance acid mixing in a battery, particularly during movement of the battery. The separator may be disposed such that the first and second surfaces are parallel to a start and stop motion of the battery. The separator may be provided with a mat adjacent to the positive electrode, the negative electrode, or the separator. The mat may be at least partially made of glass fibers, synthetic fibers, silica, at least one performance enhancing additive, latex, natural rubber, synthetic rubber, and any combination thereof. The mat may be nonwoven, woven, mesh, fleece, net, and combinations thereof.

In certain embodiments, the battery may operate at a depth of discharge of between approximately 1% and approximately 99%.

In accordance with at least selected exemplary embodiments, aspects, or objects, the present invention solves, meets, and/or overcomes at least the problems, needs, and/or issues, which have heretofore been unsolved, unmet, and/or not addressed by the current state of the art. In accordance with at least certain objects, the present invention provides an improved separator, an improved battery utilizing the improved separator, and/or an improved system using the improved battery that overcome, and in some cases surprisingly and unexpectedly overcome, at least the aforementioned problems.

### BRIEF DESCRIPTION OF THE FIGURES (OR DRAWINGS)

FIG. 1 is a schematic cutaway side-view of a typical lead acid battery having a plurality of alternating positive (+) electrodes and negative (−) electrodes, and separators interleaved therebetween.

FIG. 2A shows a plan-view depiction of a typical separator having a first surface with a plurality of ribs longitudinally disposed thereon and extending therefrom and being substantially parallel to the machine direction. FIG. 2B shows a plan-view depiction of the separator shown in FIG. 2A having a second surface, opposite to the first surface, with a plurality of cross-mini ribs laterally disposed thereon and extending therefrom and being substantially parallel to the cross-machine direction.

FIG. 3A is an end-view representation of the separator depicted in FIGS. 2A and 2B as viewed orthogonally to the cross-machine direction cmd. FIG. 3B is an end-view representation of the separator depicted in FIG. 3A as viewed orthogonally to the machine direction md.

FIG. 4 is an end-view illustration of an electrode/separator assembly possessing the separator as depicted in FIGS. 2A and 2B and FIGS. 3A and 3B, with the major ribs contacting the positive electrode and the minor ribs contacting the negative electrode.

FIG. 5A and FIG. 5B show plan-view depictions of two surfaces of an exemplary embodiment of an inventive separator of the present invention. FIG. 5A depicts a first surface with a first plurality of ribs longitudinally disposed thereon and extending therefrom and substantially parallel to the machine direction. FIG. 5B illustrates a second surface, opposite to the first surface, with a second plurality of ribs disposed longitudinally thereon and extending therefrom and being disposed substantially in the same direction as the ribs on the first surface. FIGS. 5A and 5B further show that the first plurality of ribs and the second plurality of ribs are offset from one another and not aligned over one another.

FIG. 6A and FIG. 6B are end-view illustrations of the exemplary embodiment of an inventive separator shown in FIGS. 5A and 5B defining the exemplary embodiment by physical dimensions.

FIG. 7A and FIG. 7B are end-view illustrations of electrode/separator assemblies possessing the exemplary embodiment of an inventive separator shown in FIGS. 5A through 6B. FIG. 7A shows an exemplary separator in a relaxed state. FIG. 7B shows an exemplary separator in a compressed state.

FIG. 8 and FIG. 9 are end-view illustrations of separate exemplary inventive embodiments of an inventive separator.

FIG. 10 is a plan-view depiction of an exemplary embodiment of an inventive separator having mini cross-ribs.

FIG. 11 is a plan-view depiction of an exemplary embodiment of an inventive separator the tips of serrations on serrated ribs or battlemented ribs.

FIG. 12 is a plan-view depiction of an exemplary embodiment of an inventive separator having discrete protrusions instead of ribs.

FIG. 13 is a graph showing the overall separator thickness (μm) throughout 4 stages of compression for 4 prototype separators and a control separator.

FIG. 14 is a graph showing a change in the overall thickness (μm) from a previous compression stage for 4 prototype separators and a control separator.

FIG. 15 is a graph showing a percentage (%) change in the overall thickness from a previous compression stage for 4 prototype separators and a control separator.

### DETAILED DESCRIPTION

It is appreciated that the figures (or drawings) depicted and described herein are not necessarily drawn to scale or in proportion to an actual embodiment, and the size of some features in the figures may be exaggerated or diminished for clarity.

As battery manufacturers struggle to control electrode spacing, and as uses that subject the battery to motion and vibration moves and rattles electrodes, there remains a need to provide a battery separator capable of accommodating varied electrode spacing.

In accordance with at least certain exemplary embodiments, objects, or aspects, the present disclosure or invention may provide novel or improved separators, cells, batteries, systems, methods of manufacture, use, and/or applications of such novel or improved separators, cells, batteries, and/or systems that overcome at least the aforementioned problems. For example, at least certain exemplary embodiments, objects, or aspects provide batteries with separators that are adaptable to electrodes with smaller, compressed spacing therebetween as compared to typical batteries of the present state of the art, and by providing batteries with reduced size and with an increased power to volume ratio.

In accordance with at least certain embodiments, the present disclosure or invention is directed to novel or improved separators, cells, batteries, systems, and/or methods of manufacture and/or use and/or applications of such novel separators, cells, batteries, and/or systems. In accordance with at least certain embodiments, the present disclosure or invention is directed to novel or improved battery separators for: lead acid batteries; flooded lead acid batteries; enhanced flooded lead acid batteries (“EFBs”); flat-plate batteries; tubular batteries; deep-cycle batteries; batteries operating in a partial state of charge (“PSoC”); valve regulated lead acid (“VRLA”) batteries; gel batteries; absorptive glass mat (“AGM”) batteries; inverter batteries; energy storage for electric generation, such as by steam turbine generators, such as by coal and/or gas fired power plants, and/or nuclear power plants; energy storage for electric generation by solar power, wind power, hydro-electric power, or other alternate and/or renewable energy sources; general energy storage batteries; uninterruptible power source (“UPS”) batteries; batteries with high cold-cranking ampere (“CCA”) requirements; vehicle batteries, such as starting-lighting-ignition (“SLI”) vehicle batteries, idling-start-stop (“ISS”) vehicle batteries, automobile batteries, truck batteries, motorcycle batteries, all-terrain vehicle batteries, forklift batteries, golf cart (also referred to as golf cars) batteries, hybrid-electric vehicle (“HEV”) batteries, electric vehicle batteries, light electric vehicle batteries, e-rickshaw batteries, e-trike batteries, e-bike batteries, electric scooters, and/or the like. In accordance with at least certain aspects, the present disclosure or invention is directed to improved methods of making and/or using such improved separators, cells, batteries, systems, and/or the like.

In addition, disclosed herein are exemplary inventive battery separators, methods, and systems for decreasing battery size; increasing battery power to volume ratio; increasing, enhancing, or improving battery performance and/or battery life; increasing, enhancing, or improving acid availability at the electrodes; increasing, enhancing, or improving acid diffusion; reducing or mitigating battery failure; reducing or mitigating acid stratification; reducing or mitigating dendrite formation and growth; increasing, enhancing, or improving oxidation stability; optimizing porosity; optimized tortuosity; improving, maintaining, and/or lowering float current; improving end of charge current; decreasing the current and/or voltage needed to charge and/or fully charge a deep cycle battery; increasing charge acceptance; reducing internal electrical resistance; reducing or mitigating antimony poisoning; increasing wettability; improving uniformity in a lead acid battery; improving cycle performance and/or the like. In accordance with at least particular embodiments, the present disclosure or invention is directed to an improved separator wherein the novel separator includes a relaxed state or configuration and a compressed state or configuration, a novel and improved rib design, performance enhancing additives or coatings, improved fillers, negative cross ribs, and/or the like, and combinations thereof.

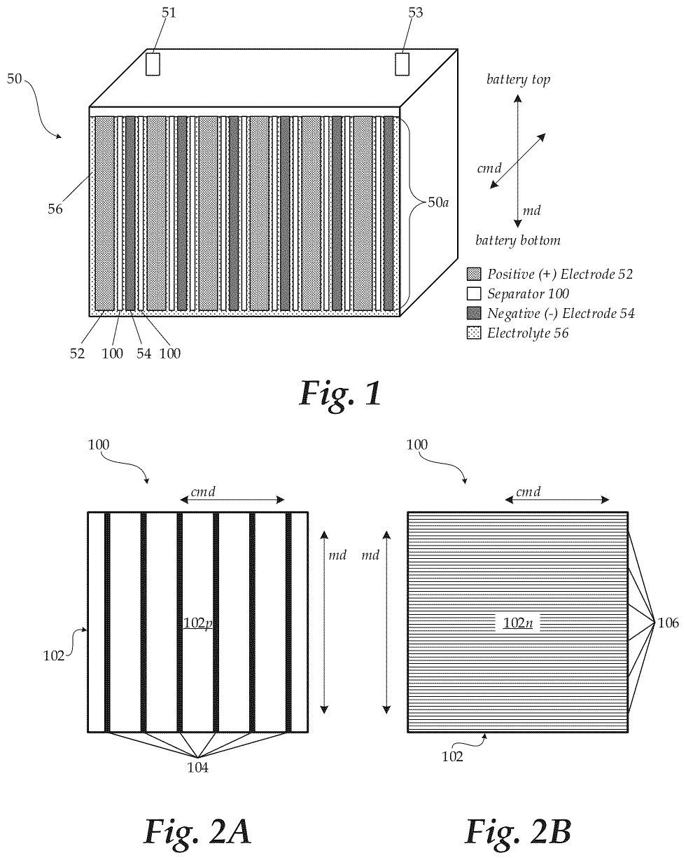

Referring now to FIG. 1, an exemplary lead acid battery 50 is provided with an electrode/separator array 50a that is provided with alternating positive electrodes 52 and negative electrodes 54, and a separator 100 disposed and interleaved between each positive electrode 52 and negative electrode 54. The electrode/separator array 50a is shown with leaf or cut-piece separators 100, however they may alternatively be formed as positive envelopes (i.e., enveloping the positive electrodes), negative envelopes (i.e., enveloping the negative electrodes), hybrid envelopes, pockets, sleeves, wraps, and/or the like, and/or a combination thereof.

The positive electrodes 52 have a grid of lead dioxide (PbO₂) that is typically doped with a positive active material (“PAM”). The negative electrodes 54 have a grid of lead (Pb) that is typically doped with a negative active material (“NAM”). Both of the PAM and NAM contribute to increasing the functionality of the electrodes. The positive and negative grids may be provided as alloys having at least one of antimony (Sb), calcium (Ca), tin (Sn), selenium (Se), and/or the like, or a combination thereof.

The exemplary lead acid battery 50 is further provided with a positive terminal 51 and a negative terminal 53. The positive terminal 51 is in electrical communication with the positive electrodes 52. Likewise, the negative terminal 53 is in electrical communication with the negative electrodes 54. The terminals 51, 53 are typically disposed on the top or side of the battery 50.

The electrodes 52, 54 and separators 100 are substantially submerged in an electrolyte 56. The electrolyte is preferably a solution of water and sulfuric acid (H₂SO₄). The electrolyte solution preferably has a specific gravity of approximately 1.28, with a range of approximately 1.215 to approximately 1.300.

The purpose of the separator is to separate and insulate the electrodes from electrical conduction with one another, which would short the battery, yet maintain ionic conduction between the electrodes via the electrolyte, which is required for the electrochemical reaction of the battery. Therefore, the separator must be electrically non-conductive, yet porous enough to allow ionic conduction. If the separator is too porous or has pores that are too large, then dendrites are likely to form large enough to bridge the gap between the electrodes and short the battery. Extremely large pores may allow direct physical contact between the electrodes.

The top and bottom of the exemplary battery 50 are labeled in FIG. 1. FIG. 1 further labels a longitudinal or machine direction md arrow and a transverse or cross-machine direction cmd arrow, which correspond to the machine direction and cross-machine direction of the separators 100. The machine direction md typically runs from the top to the bottom of the battery 50 and is substantially parallel with the separators 100, and the cross-machine direction cmd is substantially orthogonal to the machine direction md and substantially parallel with the separators 100.

Referring now to FIG. 2A and FIG. 2B, a typical separator 100 is provided with a porous membrane backweb 102 being a substantially flat web having two major opposing surfaces 102p, 102n, and, as shown, has ribs 104, 106 extending from the major opposing surfaces 102p, 102n. Exemplary porous membranes may be a microporous membrane having pores less than about 5 μm, preferably less than about 1 μm, a mesoporous membrane, or a macroporous membrane having pores greater than about 1 μm. The porous membrane may preferably have a pore size that is sub-micron up to 100 μm, and in certain embodiments between about 0.1 μm to about 10 μm. In certain embodiments, the porous membrane porosity described herein may be greater than approximately 50% to about 65%, and even up to or above approximately 70%, 75% or even 80%. In certain select embodiments, the porous membrane may be flat or possess ribs 204, 206 extending from one or more major surfaces 102p, 102n thereof.

With continued reference to FIG. 2A, a typical exemplary separator 100 is shown with a porous membrane backweb 102 and a plurality, series, array, or set of ribs 104 disposed on and extending from a first major surface 102p, and substantially aligned in a longitudinal direction that is substantially aligned in a machine direction md of the separator 100. With reference to FIG. 2B, the typical exemplary separator 100 is shown with a porous membrane backweb 102 and a plurality, series, array, or set of ribs 106 disposed on and extending from a second major surface 102n, and transversely aligned in a substantially lateral direction that is substantially aligned in a cross-machine direction cmd of the separator 100. Referring back to FIG. 1, the machine direction md is substantially aligned from the top to the bottom of the battery 50 and substantially parallel to the separators' 100 major surfaces 102p, 102n, while the cross-machine direction cmd is substantially aligned substantially orthogonally to the machine direction, horizontally, and substantially parallel to the separators' 100 major surfaces 102p, 102n. As shown throughout the figures, the machine direction is shown as the arrowed line labeled md, and cross-machine direction is shown as the arrowed line labeled cmd.

As described above, a typical commercially available battery separator 100, such as some manufactured and sold by Daramic®, is provided with a porous membrane backweb 102 having a first surface 102p, and a second opposite surface 102n. The first surface 102p may be a positive electrode facing surface when the separator 100 is disposed within a battery or battery cell assembly, and the second surface 102n may be a negative electrode facing surface when the separator 100 is disposed within a battery or battery cell. A plurality, series, array, or set of positive ribs 104 are typically disposed on and extend from the first surface 102p (positive surface), while a plurality, series, array, or set of negative ribs 106 are typically disposed on and extend from the second surface 102n (negative surface). The positive ribs 104 are sometimes referred to as major ribs as they are typically larger than the negative ribs 106, which are sometimes referred to as minor ribs. As shown in FIGS. 2A, 2B, 3A, 3B and 4, the second plurality, series, array, or set of ribs 106 are shown as cross-negative ribs with a height shorter than that of the positive ribs, and a spacing tighter than that of the positive ribs.

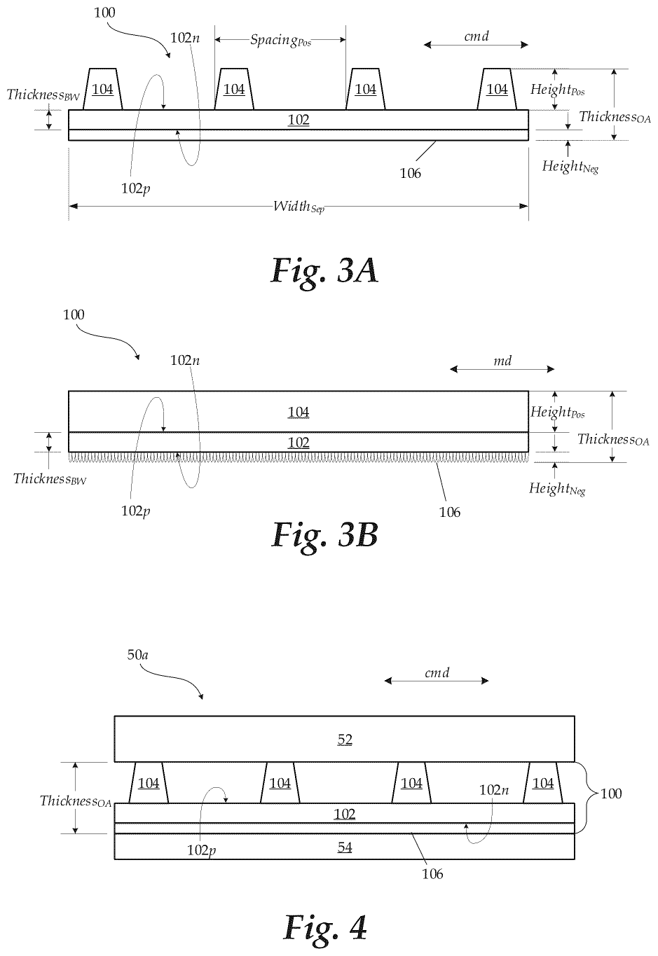

With reference now to FIGS. 3A, 3B, and 4, a typical commercially available separator 100 is defined by several dimensions. FIGS. 3A and 3B depict a typical commercially available separator 100 without a battery or battery cell assembly, while FIG. 4 depicts a typical commercially available separator 100 within a battery or battery cell assembly. FIG. 3A depicts and defines a positive rib spacing Spacing_{Pos} of the first plurality, series, array, or set of ribs 104 (i.e., positive ribs). The positive rib spacing Spacing_{Pos} is typically fixed for at least a portion of the first plurality of ribs 104, and possibly even a majority to all of the first plurality of ribs 104 across the width of the separator Width_{Sep}. Accordingly, the positive rib spacing Spacing_{Pos} may vary across the separator width Width_{Sep}. FIGS. 3A and 3B further depict and define the first plurality of ribs' 104 (i.e., positive ribs) height Height_{Pos}, the second plurality of ribs' 106 (i.e., negative ribs) height Height_{Neg}, a backweb thickness Thickness_{BW}, and an overall thickness Thickness_{OA} (also shown in FIG. 4). The overall thickness Thickness_{OA} is typically the sum of the positive rib height Height_{Pos}, the negative rib height Height_{Neg}, and the backweb thickness Thickness_{BW}. For a typical commercially available separator 100, the overall thickness Thickness_{OA} is a substantially fixed constant value whether or not the separator 100 is disposed within or without a battery or battery cell assembly. The rib height dimensions Height_{Pos}, Height_{Neg} may be variable for a given separator 100. The height dimension with the highest value would be used to determine the overall thickness Thickness_{OA}. As shown, the rib height dimensions Height_{Pos}, Height_{Neg} have a fixed value for each respective height dimensions. FIG. 4 shows the separator 100 disposed within a battery cell assembly and between a positive electrode 52 and a negative electrode 54.

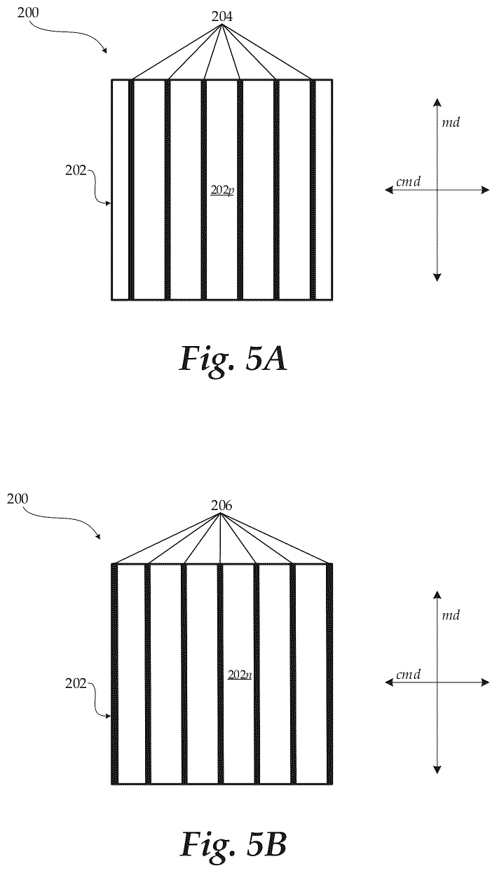

Referring now to FIG. 5A through FIG. 9, an exemplary embodiment of an inventive separator 200 of the present disclosure or invention is provided with a porous membrane backweb 202. Exemplary porous membranes of the exemplary inventive separator 200 may be a microporous membrane having pores less than about 5 μm, preferably less than about 1 μm, a mesoporous membrane, or a macroporous membrane having pores greater than about 1 μm. The porous membrane may preferably have a pore size that is sub-micron up to 100 μm, and in certain embodiments between about 0.1 μm to about 10 μm. In certain embodiments, the porous membrane porosity described herein may be greater than approximately 50% to about 65%, and even up to or above approximately 70%, 75%, or even 80%. In certain select embodiments, the porous membrane may be flat or possess ribs 204, 206 extending from one or more major surfaces 202p, 202n thereof.

An exemplary inventive separator 200 of the present disclosure or invention is provided with a porous membrane backweb 202 that is a substantially flat web having two major opposing surfaces 202p, 202n. A first plurality, series, array, or set of ribs 204 are disposed on and extend from the first surface 202p, while a second plurality, series, array, or set of ribs 204 are disposed on and extend from the second surface 202n. The first surface 202p may be a positive electrode facing surface when the separator 200 is disposed within a battery or battery cell assembly. The second surface 202n may be a negative electrode facing surface when the separator 200 is disposed within a battery or battery cell assembly. Accordingly, the first plurality, series, array, or set of ribs 204 may be referred to as positive ribs 204 and be adjacent to a positive electrode 52 when disposed within a battery or battery cell assembly, and the second plurality, series, array, or set of ribs 206 may be referred to as negative ribs 206 and be adjacent to a negative electrode 54 when disposed within a battery or battery cell assembly. As shown, the first plurality of ribs 204 and the second plurality of ribs 206 are substantially aligned with and parallel to a machine direction of the separator 200 and to one another. In addition, at least a portion of the first plurality of ribs 204 are offset from and not aligned with any ribs of the second plurality of ribs 206. As shown in FIG. 5A through FIG. 9, none of the first plurality of ribs 204 are aligned with any of the ribs of the second plurality of ribs 206.

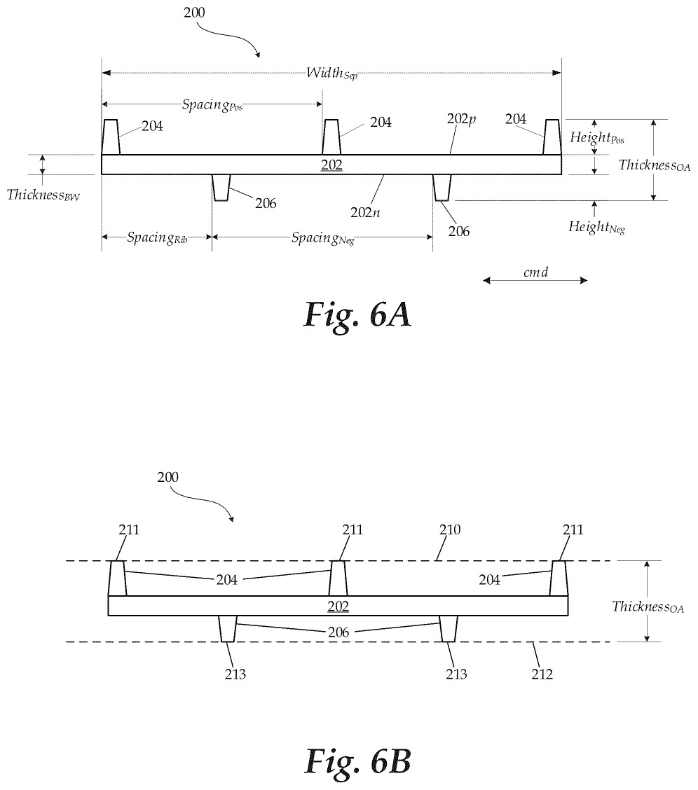

Referring now to FIG. 6A, an embodiment of an exemplary separator 200 is defined by several physical dimensions. The first plurality, series, array, or set of ribs 204 (i.e., positive ribs) have a height dimension Height_{Pos} and a spacing dimension Spacing_{Pos} across the separator width Width_{Sep}. The positive rib spacing Spacing_{Pos} may be fixed or constant for at least a portion of the first plurality of ribs 204, and possibly even a majority to all of the first plurality of ribs 204 across the separator width Width_{Sep}. Accordingly, the positive rib spacing Spacing_{Pos} may be fixed or constant, and/or vary across the separator width Width_{Sep}. When the positive rib spacing Spacing_{Pos} is fixed or constant, the positive ribs 204 are equidistantly disposed across the separator width Width_{Sep}. As shown, the positive rib spacing Spacing_{Pos} is fixed. The second plurality, series, array, or set of ribs 206 (i.e., negative ribs) have a height dimension Height_{Neg} and a spacing dimension Spacing_{Neg} across the separator width Width_{Sep}. The negative rib spacing Spacing_{Neg} may be fixed for at least a portion of the second plurality of ribs 206, and possibly even a majority to all of the second plurality of ribs 206 across the separator width Width_{Sep}. Accordingly, the negative rib spacing Spacing_{Pos} may be fixed or constant, and/or vary across the separator width Width_{Sep}. As shown, the negative rib spacing Spacing_{Pos} is fixed. When the negative rib spacing Spacing_{Neg} is fixed or constant, the negative ribs 206 are equidistantly disposed across the separator width Width_{Sep}. The height dimensions Height_{Pos}, Height_{Neg} are defined as the height of the ribs 204, 206 as measured from the respective surface 102p, 102n of the backweb 202 from which the rib 204, 206 extends from. The height dimensions Height_{Pos}, Height_{Neg} may or may not be equal. Furthermore, the height dimensions Height_{Pos}, Height_{Neg} may be fixed or constant for all ribs—meaning that all the ribs are the same height. Conversely, the positive ribs height Height_{Pos} may vary among the positive ribs 204, and the negative rib height Height_{Neg} may vary among the negative ribs 204.

With continued reference to FIG. 6A, the embodiment of an exemplary novel separator 200 is further provided with an overall rib spacing dimension Spacing_{Rib} that is the distance from one rib to the next rib without regard to the side of the backweb on which the rib is disposed. As shown, the positive rib spacing Spacing_{Pos} is equal to the negative rib spacing Spacing_{Neg}. As is further shown, the overall rib spacing Spacing_{Rib} is fixed or constant across at least a portion of or all of the separator width Width_{Sep}, such that the ribs 204, 206 are overall equidistantly spaced apart. However, the positive rib spacing Spacing_{Pos} may be equal to the negative rib spacing Spacing_{Neg} without the overall rib spacing Spacing_{Rib} being fixed or constant across the separator width Width_{Sep}.

In at least certain select embodiments of novel separators 200, the positive rib spacing dimension Spacing_{Pos} is preferably equal to the negative rib spacing dimension Spacing_{Neg}. Furthermore, the overall rib spacing dimension Spacing_{Rib} is preferably equal to half of the positive rib and negative rib spacing dimensions Spacing_{Pos}, Spacing_{Neg}.

With reference to FIG. 6B, embodiments of an exemplary inventive separator 200 is further defined by an overall thickness Thickness_{OA}. The overall thickness Thickness_{OA}, is defined as the distance from a first plane 210 to a second plane 212. The first plane 210 is generally and substantially coplanar with the tips 211 of the first plurality of ribs 204. The second plane 212 is generally and substantially coplanar with the tips 213 of the second plurality of ribs 206. The tips 211, 213 of the ribs being defined as the point(s) of the ribs 204, 206 farthest from the separator backweb 202.

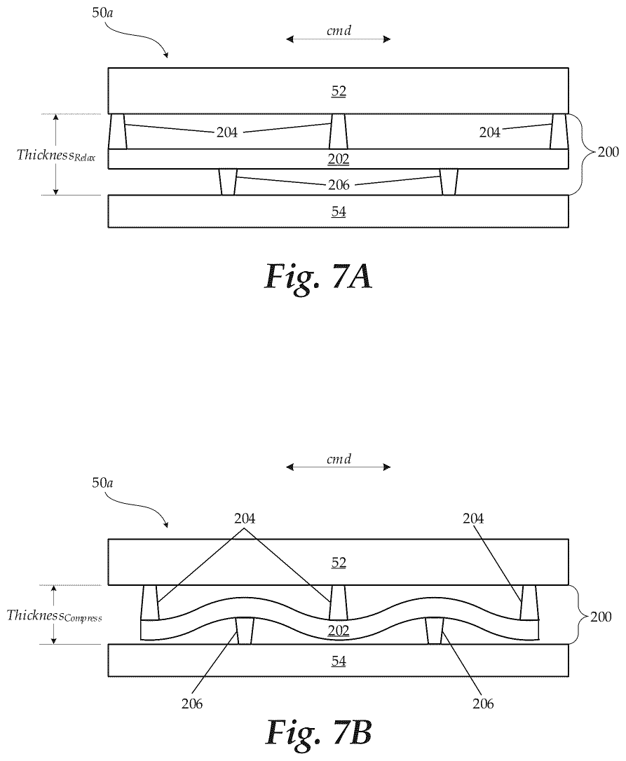

With reference now to FIG. 7A and FIG. 7B, an exemplary novel separator 200 is disposed between a positive electrode 52 and a negative electrode 54. FIG. 7A illustrates an exemplary novel separator 200 in a disposed in an electrode/separator assembly 50a in a relaxed state—meaning that the separator is not under compression. In FIG. 7A, the novel separator 200 has an overall relaxed thickness Thickness_{Relax}. FIG. 7B represents an exemplary novel separator 200 in a disposed in an electrode/separator assembly 50a in a compressed state—meaning that the separator is under compression. In FIG. 7B, the novel separator 200 has an overall compressed thickness Thickness_{Compress}. It is appreciated that the compressed thickness Thickness_{Compress} is smaller than the relaxed thickness Thickness_{Relax}.

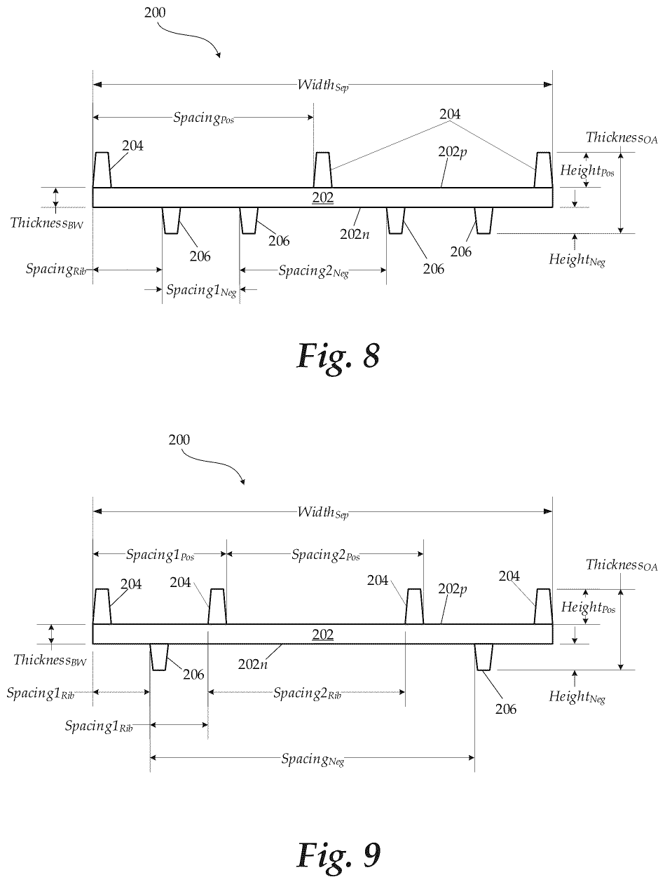

With reference now to FIG. 8, an exemplary novel separator 200 is defined by several dimensions as generally described hereinabove. In particular select embodiments, the positive ribs 204 are equidistantly spaced apart by a fixed or constant spacing distance Spacing_{Pos}, and the negative ribs 206 are variably spaced apart by multiple rib spacing distances Spacing1_{Neg}, Spacing2_{Neg}. Despite the fact that the negative ribs spacing Spacing1_{Neg}, Spacing2_{Neg} is varied, the overall rib spacing Spacing_{Rib} can be constant such that the ribs 204, 206 are equidistantly spaced apart.

Referring to FIG. 9, an exemplary novel separator 200 is defined by several dimensions as generally described hereinabove. In particular select embodiments, the positive ribs 204 are variably spaced apart by multiple rib spacing distances Spacing1_{Pos}, Spacing2_{Pos}. The negative ribs 206 equidistantly spaced apart by a fixed or constant spacing distance Spacing_{Neg}. FIG. 9 presents a configuration with a varied overall rib spacing. As shown, the overall ribs 204, 206 are variably spaced apart by multiple rib spacing distances Spacing1_{Rib}, Spacing2_{Rib}.

Though not shown in the figures, it is contemplated that instead of just one of the positive ribs 204 or the negative ribs 206 having multiple rib spacing distances, both the positive ribs 204 and negative ribs 206 may have variable or multiple rib spacing distances. In addition, the overall rib spacing Spacing_{Rib} may be fixed or variable regardless of the positive rib spacing Spacing_{Pos} or negative rib spacing Spacing_{Neg} values.

As shown in FIGS. 6A, 8, and 9, the rib spacing distance dimensions Spacing_{Rib}, Spacing1_{Rib}, Spacing2_{Rib}, Spacing_{Pos}, Spacing1_{Pos}, Spacing2_{Pos}, Spacing_{Neg}, Spacing1_{Neg}, and Spacing2_{Neg}, are measured from an edge of a rib to the edge of the next rib, but may also be measured center to center. This may be more accurate if the rib widths vary between separator surfaces or on a common surface. In select exemplary embodiments, the positive rib spacing may be between approximately 1.0 mm and approximately 12 mm, preferably between approximately 2.0 mm and approximately 9.0 mm, and more preferably between approximately 4.0 mm and approximately 6.0 mm. In certain exemplary embodiments, the negative rib spacing may be between approximately 1.0 mm and approximately 12 mm, preferably between approximately 2.0 mm and approximately 9.0 mm, and more preferably between approximately 4.0 mm and approximately 6.0 mm. In select embodiments, the positive rib spacing and negative rib spacing may preferably be substantially equal to one another. The overall rib spacing may generally be balanced and consistent, or fixed, across the separator width at a preferred value of 50% of the positive/negative rib spacing. Thus, a negative rib would be centered in the middle between two positive ribs (yet on the opposite surface of the positive ribs), and a positive rib would be centered in the middle between two negative ribs (yet on the opposite surface of the negative ribs).

In some preferred exemplary embodiments, the backweb thickness may be between approximately 100 μm and approximately 300 μm, preferably between approximately 150 μm and approximately 250 μm, and more preferably between approximately 175 μm and approximately 225 μm.

In certain preferred exemplary embodiments, the rib heights may be between approximately 100 μm and approximately 600 μm, preferably between approximately 150 μm and approximately 500 μm, and more preferably between approximately 200 μm and approximately 400 μm. In select exemplary embodiments, the positive rib height and negative rib height may be substantially equal to one another. Alternatively, one set of ribs may be between approximately between 100% and approximately 500% of the height of the other set of ribs, and preferably between approximately 100% and approximately 300%.

While the rib spacing dimensions, backweb thickness dimensions, and rib height dimensions enumerated above are preferred for select embodiments, it is appreciated that these dimensions may be outside these ranges and remain in the scope of the present invention.

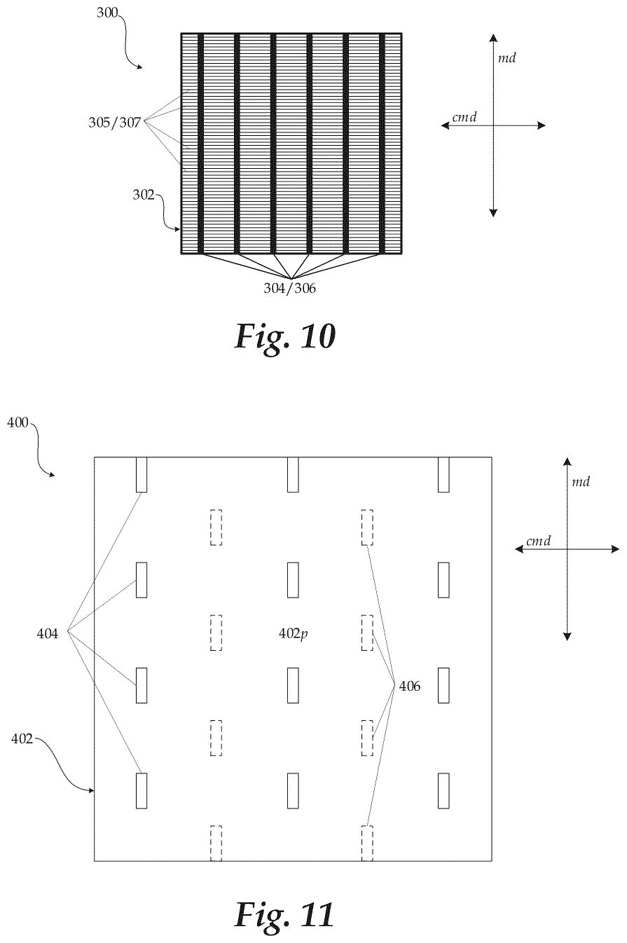

Referring to FIG. 10, an exemplary separator 300 of the present invention is provided with a generally flat backweb 302 with a set of major ribs 304/306 disposed thereon and extending therefrom. Additionally, mini-cross ribs 305/307 may be disposed on either or both sides of the separator backweb 302 and between the major ribs 304/306. These mini ribs 305/307 provide stiffness in a cross-machine direction cmd, and a means to reduce weight/material from the separator 300. Is it appreciated that the nomenclature of the reference numerals refers to a first plurality of major ribs 304, and a first set of mini-cross ribs 305 on a first surface of the separator backweb 302; and a second plurality of major ribs 306, and a second set of mini-cross ribs 307 on a second surface of the separator backweb 302. If disposed on a negative electrode facing surface, the mini-cross ribs 305/307 may be referred to as negative cross ribs.

With reference now to FIG. 11, an exemplary separator 400 of the present invention is provided a generally flat backweb 402 with serrated ribs 404, 406 disposed thereon and extending therefrom. A first plurality of serrated ribs 404 is provided disposed on a first surface 102p, and a second plurality of serrated ribs 406 (depicted with dashed-lines) is provided disposed on a surface opposite of the first surface 402p. As can be seen, both pluralities of serrated ribs 404, 406 are offset from one another, and the tips of the serrations are also offset from one another. The serrated ribs 404, 406 may also or alternatively be battlemented ribs as generally described in U.S. Pat. No. 7,094,498 to Miller, et al., which is incorporated herein by reference.

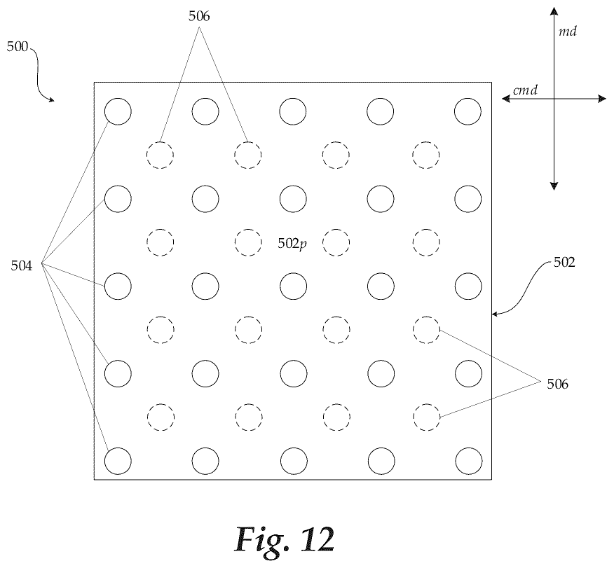

With reference now to FIG. 12, an exemplary separator 500 of the present invention is provided a generally flat backweb 502 with protrusions 504, 506 disposed thereon and extending therefrom. A first plurality of protrusions 504 is provided disposed on a first surface 102p, and a second plurality of protrusions 506 (depicted with dashed-lines) is provided disposed on a surface opposite of the first surface 502p. As can be seen, both pluralities of protrusions 504, 506 are offset from one another, and the tips of the protrusions are also offset from one another. The protrusions 504, 506 may also or alternatively be embossments or embossed ribs as generally described in U.S. Pat. No. 9,461,291 to Miller, et al., which is incorporated herein by reference.

As discussed herein, current separators marketed, sold, and used in flooded lead acid batteries, particularly flooded lead acid batteries that operate or are intended to operate at a partial state of charge exhibit the above-described squeezing and displacement of acid, which eventually leads to an inoperable battery. Thus, there is a need for improved separators for flooded lead acid batteries, particularly flooded lead acid batteries that operate at a partial state of charge (e.g., those used in start/stop vehicles, electric vehicles, light electric vehicles, hybrid vehicles, power collection inverters, and/or the like), with improved acid availability at the electrodes in a partial state of charge.

In select embodiments, the positive or negative ribs may generally be any of or combination of: solid or continuous, serrated, discontinuous, discrete teeth or toothed ribs, discrete broken ribs, battlements, and/or battlemented ribs; linear, curved, wavy, angled, continuous or discontinuous zig-zag-sawtooth type ribs, and/or sinusoidal ribs; longitudinally extending ribs substantially in a machine direction of the separator, laterally extending ribs substantially in a cross-machine direction of the separator, transversely extending ribs substantially in said cross-machine direction of the separator, grooves, channels, textured areas, embossments, discrete protrusions, dimples, columns, mini columns, porous, non-porous, mini ribs, cross-mini ribs, acid mixing ribs, and combinations thereof.

In exemplary select embodiments, acid-mixing ribs may be on either or both of the positive or negative ribs and may be any form or combination of being defined by an angle that is neither parallel nor orthogonal relative to an edge of the separator. Furthermore, that angle may vary throughout the columns, rows, and/or discrete elements of the ribs. The angled rib pattern may possibly be a preferred Daramic® RipTide™ acid mixing rib profile that can help reduce, eliminate, and/or mitigate acid stratification in certain batteries, and/or reverse the affects and/or state of acid stratification in certain batteries. Moreover, the angle may be defined as being relative to a machine direction of the porous membrane and the angle may between approximately greater than zero degrees (0°) and approximately less than 180 degrees (180°), and approximately greater than 180 degrees (180°) and approximately less than 360 degrees (360°).

The ribs may extend uniformly across the width of the separator, from lateral edge to lateral edge. This is known as a universal profile. Alternatively, the separator may have side panels adjacent to the lateral edges with rib pattern different than that of the primary ribs. Alternatively, the side panels may alternatively be flat. The side panels may assist in sealing an edge of the separator to another edge of the separator as done when enveloping the separator, which is discussed hereinafter.

The separator 100 may be provided as a leaf or leaves, a wrap, a sleeve, or as an envelope or pocket separator. An exemplary envelope separator may envelope a positive electrode (“positive enveloping separator”), such that the separator has two interior sides facing the enveloped positive electrode and two exterior sides facing adjacent negative electrodes. Alternatively, another exemplary envelope separator may envelope a negative electrode (“negative enveloping separator”), such that the separator has two interior sides facing the enveloped negative electrode and two exterior sides facing adjacent positive electrodes. In such enveloped separators, the bottom edge 103 may be a folded or a sealed crease edge. Further, the lateral edges may be continuously or intermittently sealed seam edges. The edges may be pinch sealed, bonded or sealed by adhesive, heat, ultrasonic welding, and/or the like, or any combination thereof.

Certain exemplary separators may be processed to form hybrid envelopes. The hybrid envelope may be provided by forming one or more slits or openings before, during or after, folding the separator sheet in half and sealing edges of the separator sheet together so as to form an envelope. The length of the openings may be at least 1/50, 1/25, 1/20, 1/15, 1/10, ⅛, ⅕, ¼ or ⅓ the length of the entire edge. The length of the openings may be 1/50 to ⅓, 1/25 to ⅓, 1/20 to ⅓, 1/20 to ¼, 1/15 to ¼, 1/15 to ⅕, or 1/10 to ⅕ the length of the entire edge. The hybrid envelope can have 1-5, 1-4, 2-4, 2-3 or 2 openings, which may or may not be equally disposed along the length of the bottom edge. It is preferred that no opening is in the corner of the envelope. The slits may be cut after the separator has been folded and sealed to give an envelope, or the slits may be formed prior to shaping the porous membrane into an envelope.

It is appreciated that the exemplary embodiments of inventive separators of the present disclosure or invention may be configured such that what is described as a positive electrode facing surface, positive ribs, and the like may be utilized as a negative electrode facing surface, negative ribs, and the like. Accordingly, the exemplary embodiments of inventive separators of the present disclosure or invention may be configured such that what is described as a negative electrode facing surface, negative ribs, and the like may be utilized as a positive electrode facing surface, positive ribs, and the like. Additionally, a positive envelope, positive hybrid envelope, positive sleeved, positive pockets, and the like may also be utilized as a negative envelope, negative hybrid envelope, negative sleeved, negative pockets, and the like, and vice versa. In general, embodiments of the invention that refer to a positive side, object, or electrodes may be replaced with references to a negative side, object, or electrodes, and vice versa without deviating from the scope of the invention.

In certain embodiments, the improved separator, including a porous membrane and ribs, may be made of: a natural or synthetic base material; a processing plasticizer; a filler; natural or synthetic rubber(s) or latex, and one or more other additives and/or coatings, and/or the like.

In certain embodiments, exemplary natural or synthetic base materials may include: polymers; thermoplastic polymers; phenolic resins; natural or synthetic rubbers; synthetic wood pulp; lignins; glass fibers; synthetic fibers; cellulosic fibers; and combinations thereof. In certain preferable embodiments, an exemplary separator may contain thermoplastic polymers. Exemplary thermoplastic polymers may, in principle, include all acid-resistant thermoplastic materials suitable for use in lead acid batteries. In certain preferred embodiments, exemplary thermoplastic polymers may include polyvinyls and polyolefins. In certain embodiments, the polyvinyls may include, for example, polyvinyl chloride (“PVC”). In certain preferred embodiments, the polyolefins may include, for example, polyethylene, polypropylene, ethylene-butene copolymer, and combinations thereof, but preferably polyethylene. In certain embodiments, exemplary natural or synthetic rubbers may include, for example, latex, uncross-linked or cross-linked rubbers, crumb or ground rubber, and any combination thereof.

In select exemplary embodiments, the separator may preferably include a polyolefin, specifically polyethylene. Preferably, the polyethylene is high molecular weight polyethylene (“HMWPE”). Exemplary HMWPE may have a molecular weight of at least 600,000. Even more preferably, the polyethylene is ultra-high molecular weight polyethylene (“UHMWPE”). Exemplary UHMWPE may have a molecular weight of at least 1,000,000, in particular more than 4,000,000, and most preferably 5,000,000 to 8,000,000 as measured by viscosimetry and calculated by Margolie's equation. Further, exemplary UHMWPE may possess a standard load melt index of substantially zero (0) as measured as specified in ASTM D 1238 (Condition E) using a standard load of 2,160 g. Moreover, exemplary UHMWPE may have a viscosity number of not less than 600 ml/g, preferably not less than 1,000 ml/g, more preferably not less than 2,000 ml/g, and most preferably not less than 3,000 ml/g, as determined in a solution of 0.02 g of polyolefin in 100 g of decalin at 130° C.

The novel separator disclosed herein may contain latex and/or rubber. As used herein, rubber shall describe, rubber, latex, natural rubber, synthetic rubber, cross-linked or uncross-linked rubbers, cured or uncured rubber, crumb or ground rubber, or mixtures thereof. Exemplary natural rubbers may include one or more blends of polyisoprenes, which are commercially available from a variety of suppliers. Exemplary synthetic rubbers include methyl rubber, polybutadiene, chloroprene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

In certain embodiments, exemplary processing plasticizers may include processing oil, petroleum oil, paraffin-based mineral oil, mineral oil, and any combination thereof.

The separator may contain a filler having a high structural morphology. Exemplary fillers can include: silica, dry finely divided silica; precipitated silica; amorphous silica; highly friable silica; alumina; talc; fish meal; fish bone meal; carbon; carbon black; and the like, and combinations thereof. In certain preferred embodiments, the filler is one or more silicas. High structural morphology refers to increased surface area. The filler can have a high surface area, for instance, greater than approximately 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, or 250 m²/g. In some embodiments, the filler (e.g., silica) may have a surface area from about 100 m²/g to 300 m²/g, 125 m²/g to 275 m²/g, 150 m²/g to 250 m²/g, or preferably 170 m²/g to 220 m²/g. Surface area can be assessed using TriStar 3000™ for multipoint BET nitrogen surface area. High structural morphology permits the filler to hold more oil during the manufacturing process. For instance, a filler with high structural morphology has a high level of oil absorption, for instance, greater than about 150 ml/100 g, 175 ml/100 g, 200 ml/100 g, 225 ml/100 g, 250 ml/100 g, 275 ml/100 g, 300 ml/100 g, 325 ml/100 g, or 350 ml/100 g. In some embodiments the filler (e.g., silica) can have an oil absorption from approximately 200 ml/100 g to 500 ml/100 g, 200 ml/100 g to 400 ml/100 g, 225 ml/100 g to 375 ml/100 g, 225 ml/100 g to 350 ml/100 g, 225 ml/100 g to 325 ml/100 g, preferably 250 ml/100 g to 300 ml/100 g. In some instances, a silica filler is used having an oil absorption of 266 ml/100 g. Such a silica filler has a moisture content of 5.1%, a BET surface area of 178 m²/g, an average particle size of approximately 23 μm, a sieve residue about 230 mesh value of 0.1%, and a bulk density of about 135 g/L.

Silica with relatively high levels of oil absorption and relatively high levels of affinity for the plasticizer (e.g., mineral oil) becomes desirably dispersible in the mixture of polyolefin (e.g., polyethylene) and the plasticizer when forming an exemplary lead acid battery separator of the type shown herein. In the past, some separators have experienced the detriment of poor dispersibility caused by silica aggregation when large amounts of silica are used to make such separators or membranes. In at least certain inventive separators shown and described herein, the polyolefin, such as polyethylene, forms a shish-kebab structure, since there are few silica aggregations or agglomerates that inhibit the molecular motion of the polyolefin at the time of cooling the molten polyolefin. All of this contributes to improved ion permeability through the resulting separator membrane, and the formation of the shish-kebab structure or morphology means that mechanical strength is maintained or even improved while a lower overall ER separator is produced.

In some select embodiments, the filler (e.g., silica) has an average particle size no greater than about 25 μm, in some instances, no greater than about 22 μm, 20 μm, 18 μm, 15 μm, or 10 μm. In some instances, the average particle size of the filler particles is about 15 μm to about 25 μm. The particle size of the silica filler and/or the surface area of the silica filler contributes to the oil absorption of the silica filler. Silica particles in the final product or separator may fall within the sizes described above.

However, the initial silica used as raw material may come as one or more agglomerates and/or aggregates and may have sizes around 200 μm or more.

In some preferred embodiments, the silica used to make the inventive separators has an increased amount of or number of surface silanol groups (surface hydroxyl groups) compared with silica fillers used previously to make lead acid battery separators. For example, the silica fillers that may be used with certain preferred embodiments herein may be those silica fillers having at least about 10%, at least about 15%, at least about 20%, at least about 25%, at least about 30%, or at least about 35% more silanol and/or hydroxyl surface groups compared with known silica fillers used to make known polyolefin lead acid battery separators.

The ratio (Si—OH)/Si of silanol groups (Si—OH) to elemental silicon (Si) can be measured, for example, as follows.

1. Freeze-crush a polyolefin porous membrane (where certain inventive membranes contain a certain variety of oil-absorbing silica according to the present invention), and prepare the powder-like sample for the solid-state nuclear magnetic resonance spectroscopy (²⁹Si-NMR).
2. Perform the ²⁹Si-NMR to the powder-like sample, and observe the spectrums including the Si spectrum strength which is directly bonding to a hydroxyl group (Spectrum: Q₂ and Q₃) and the Si spectrum strength which is only directly bonding to an oxygen atom (Spectrum: Q₄), wherein the molecular structure of each NMR peak spectrum can be delineated as follows:
Q₂: (SiO)₂—Si*—(OH)₂: having two hydroxyl groups
Q₃: (SiO)₃—Si*—(OH): having one hydroxyl group
Q₄: (SiO)₄—Si*: All Si bondings are SiO
   Where Si* is proved element by NMR observation.
   3. The conditions for ²⁹Si-NMR used for observation are as follows:
Instrument: Bruker BioSpin Avance 500
Resonance Frequency: 99.36 MHz
Sample amount: 250 mg
NMR Tube: 7 mφ
Observing Method: DD/MAS
Pulse Width: 45°
Repetition time: 100 sec
Scans: 800
Magic Angle Spinning: 5,000 Hz
Chemical Shift Reference: Silicone Rubber as −22.43 ppm
   4. Numerically, separate peaks of the spectrum, and calculate the area ratio of each peak belonging to Q₂, Q₃, and Q₄. After that, based on the ratios, calculate the molar ratio of hydroxyl groups (—OH) bonding directly to Si. The conditions for the numerical peak separation is conducted in the following manner:
Fitting region: −80 to −130 ppm
Initial peak top: −93 ppm for Q₂, −101 ppm for Q₃, −111 ppm for Q₄, respectively.
Initial full width half maximum: 400 Hz for Q₂, 350 Hz for Q₃, 450 Hz for Q₄, respectively.
Gaussian function ratio: 80% at initial and 70% to 100% while fitting.
   5. The peak area ratios (Total is 100) of Q₂, Q₃, and Q₄ are calculated based on the each peak obtained by fitting. The NMR peak area corresponded to the molecular number of each silicate bonding structure (thus, for the Q₄ NMR peak, four Si—O—Si bonds are present within that silicate structure; for the Q₃ NMR peak, three Si—O—Si bonds are present within that silicate structure while one Si—OH bond is present; and for the Q₂ NMR peak, two Si—O—Si bonds are present within that silicate structure while two Si—OH bonds are present). Therefore each number of the hydroxyl group (—OH) of Q₂, Q₃, and Q₄ is multiplied by two (2), one (1), and zero (0), respectively. These three results are summed. The summed value displays the mole ratio of hydroxyl groups (—OH) directly bonding to Si.

In certain embodiments, the silica may have a molecular ratio of OH to Si groups, measured by ²⁹Si-NMR, that may be within a range of approximately 21:100 to approximately 35:100, in some preferred embodiments approximately 23:100 to approximately 31:100, in certain preferred embodiments, approximately 25:100 to approximately 29:100, and in other preferred embodiments at least approximately 27:100 or greater.

In some select embodiments, use of the fillers described above permits the use of a greater proportion of processing oil during the extrusion step. As the porous structure in the separator is formed, in part, by removal of the oil after the extrusion, higher initial absorbed amounts of oil results in higher porosity or higher void volume. While processing oil is an integral component of the extrusion step, oil is a non-conducting component of the separator. Residual oil in the separator protects the separator from oxidation when in contact with the positive electrode. The precise amount of oil in the processing step may be controlled in the manufacture of conventional separators. Generally speaking, conventional separators are manufactured using about 50% to 70% processing oil, in some embodiments, about 55% to 65%, in some embodiments, approximately 60% to 65%, and in some embodiments, about 62% by weight processing oil. Reducing oil below about 59% is known to cause burning due to increased friction against the extruder components. However, increasing oil much above the prescribed amount may cause shrinking during the drying stage, leading to dimensional instability. Although previous attempts to increase oil content resulted in pore shrinkage or condensation during the oil removal, separators prepared as disclosed herein exhibit minimal, if any, shrinkage and condensation during oil removal. Thus, porosity can be increased without compromising pore size and dimensional stability, thereby decreasing electrical resistance.

In certain select embodiments, the use of the filler described above allows for a reduced final oil concentration in the finished separator. Since oil is a non-conductor, reducing oil content can increase the ionic conductivity of the separator and assist in lowering the ER of the separator. As such, separators having reduced final oil contents can have increased efficiency. In certain select embodiments are provided separators having a final processing oil content (by weight) less than 20%, for example, between about 14% and 20%, and in some particular embodiments, less than about 19%, 18%, 17%, 16%, 15%, 14%, 13%, 12%, 11%, 10%, 9%, 8%, 7%, 6%, or 5%.

The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

In certain embodiments, a separator may contain a performance-enhancing additive in the form of a conductive element or a nucleation additive and/or coating. The conductive element or nucleation additive may preferably be stable in the battery electrolyte, and may further be dispersed within the electrolyte.

Exemplary forms of conductive elements and/or coatings may be or contain carbon, such as carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof. In addition to these many forms of carbon, the nucleation additive and/or coating may also include or contain barium sulfate (BaSO₄) either alone or in combination with carbon. One exemplary form of carbon is PBX®-135, manufactured by Cabot Corporation of Boston, MA, USA. One exemplary preferred form of carbon is PBX®-51 manufactured by Cabot Corporation of Boston, MA, USA. The inventors theorize that the greater the surface area of the carbon, the greater the dynamic charge acceptance in the battery. For example, PBX®-51 has a specific surface area of at least approximately 1,300 m²/g to approximately 1,500 m²/g, and keitjen black has a surface area of at least approximately 1,250 m²/g.

The nucleation coating may be applied to a finished separator by such means as a slurry coating, slot die coating, spray coating, curtain coating, ink jet printing, screen printing, or by vacuum deposition or chemical vapor deposition (“CVD”). In addition, the additive and/or coating may be provided as carbon paper, either woven or nonwoven, and disposed between and in intimate contact with the separator and electrode(s).

The nucleation additive and/or coating may be within the separator, or on one or both electrode facing surfaces of the separator. Typically, a coating or layer of the nucleation additive may only be on the negative electrode facing surface. However, it may be on the positive electrode facing surface, or on both surfaces.

In certain embodiments, the nucleation additive may be added to the extrusion mix of base materials and extruded with the separator, or co-extruded as a layer on the separator. When included in the extrusion mix, the nucleation additive may replace some of the silica filler by as much as about 5% to about 75% by weight. For example, the nucleation additive may be approximately 5%, 10%, 15%, 20%, 25%, 30%, 35%, 40%, 45%, 50%, 55%, 60%, 65%, 70%, or approximately 75% by weight. In other exemplary embodiments, the nucleation additive may be no greater than approximately 75%, 70%, 65%, 60%, 55%, 50%, 45%, 40%, 35%, 30%, 25%, 20%, 15%, 10%, or approximately 5% weight.

In certain select embodiments, the filler may be an alumina, talc, silica, or combinations thereof. In some embodiments, the filler may be a precipitated silica, and in some embodiments, the precipitated silica may be amorphous silica. In some embodiments, it is preferred to use aggregates and/or agglomerates of silica which allow for a fine dispersion of filler throughout the separator, thereby optimizing tortuosity and decreasing electrical resistance. In certain preferred embodiments, the filler (e.g., silica) is characterized by a high level of friability. Good friability enhances the dispersion of the filler throughout the polymer during extrusion of the porous membrane, enhancing porosity and thus overall ionic conductivity through the separator.

The use of a filler having one or more of the above characteristics enables the production of a separator having a higher final porosity. The separators disclosed herein can have a final porosity greater than about 60%, 61%, 62%, 63%, 64%, 65%, 66%, 67%, 68%, 69%, 70%, 75%, or 80%. Porosity may be measured using gas adsorption methods. Porosity can be measured by BS-TE-2060.

In some select embodiments, the porous separator can have a greater proportion of larger pores while maintaining the average pore size no greater than about 1 μm, 0.9 μm, 0.8 μm, 0.7 μm, 0.6 μm, 0.5 μm, or 0.1 μm.

In accordance with at least one embodiment, the separator is made up of polyethylene, such as an UHMWPE, mixed with a processing oil and filler as well as any desired additive. In accordance with at least one other embodiment, the separator is made up of an UHMWPE mixed with a processing oil and talc. In accordance with at least one other embodiment, the separator is made up of UHMWPE mixed with a processing oil and silica, for instance, precipitated silica, for instance, amorphous precipitated silica. The additive can then be applied to the separator via one or more of the techniques described above.

Besides reducing electrical resistance and increasing cold cranking amps, preferred separators are also designed to bring other benefits. With regard to assembly, the separators are more easily passed through processing equipment, and therefore more efficiently manufactured. To prevent shorts during high speed assembly and later in life, the separators have superior puncture strength and oxidation resistance when compared to standard PE separators. Combined with reduced electrical resistance and increased cold cranking amps, battery manufacturers are likely to find improved and sustained electrical performance in their batteries with these new separators.

In certain select exemplary aspects, the inventive separator may be provided with a carbon and/or nucleation additive layer or filler. That nucleation additive may be conductive, and be one of either carbon or barium sulfate (BaSO₄). Exemplary carbon additives may be carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and combinations thereof. The conductive element or nucleation additive may have a specific surface area of at least approximately 1,250 m²/g to approximately 1,750 m²/g, or more. The nucleation additive or conductive element may be an additive within the separator, or an additive on a surface of the separator. The conductive element or nucleation additive may be applied to a surface of a separator, scrim, and/or mat by a method selected from the group consisting of; roller coating, chemical vapor deposition, co-extrusion, a controlled burn to char said surface, a controlled burn to char said surface via plasma exposure, a controlled burn to char said surface via UV exposure, toner printing, ink-jet printing, flexography printing, lithography printing, slurry coating, spraying an aqueous carbon suspension, impregnation, and combinations thereof.

In certain embodiments, exemplary separators may contain one or more performance enhancing additives added to the separator or porous membrane. The performance enhancing additive may be surfactants, wetting agents, colorants, antistatic additives, an antimony suppressing additive, UV-protection additives, antioxidants, and/or the like, and combinations thereof. In certain embodiments, the additive surfactant(s) may be ionic, cationic, anionic, or non-ionic surfactants.

In certain embodiments described herein, a reduced amount of anionic or non-ionic surfactant is added to the inventive porous membrane or separator. Because of the lower amount of surfactant, a desirable feature may include lowered Total Organic Carbons (“TOCs”) and/or lowered Volatile Organic Compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Certain suitable surfactants may have HLB values less than 6, preferably less than 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (I)

in which:
R is a linear or non-aromatic hydrocarbon radical with 10 to 4200 carbon atoms, preferably 13 to 4200, which may be interrupted by oxygen atoms;
R¹=H, —(CH₂)ₖCOOM_{1/x}^{x+}, or —(CH₂)ₖ—SO₃M_{1/x}^{x+}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 1400; and
x=1 or 2.
   The ratio of oxygen atoms to carbon atoms in the compound according to Formula (I) being in the range from about 1:1.5 to 1:30 and m and n not being able to simultaneously be zero (0). However, preferably only one of the variables n and m is different from zero (0).

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction.

Battery separators are preferred which contain a compound according to Formula (I) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)ₚ(OC₃H₆)_{q}]—, in which:
   R² is an alkyl radical with 10 to 30 carbon atoms, preferably 12 to 25, particularly preferably 14 to 20 carbon atoms, wherein R² can be linear or non-linear such as containing an aromatic ring;
   P is an integer from 0 to 30, preferably 0 to 10, particularly preferably 0 to 4; and
   q is an integer from 0 to 30, preferably 0 to 10, particularly preferably 0 to 4;
   compounds being particularly preferred in which the sum of p and q is 0 to 10, in particular 0 to 4;
n=1; and
m=0.
   Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃H₆) groups.

Additives in which R² is a straight-chain or branched alkyl radical with 10 to 20, preferably 14 to 18 carbon atoms have proved to be particularly advantageous. OC₂H₄ preferably stands for OCH₂CH₂, OC₃H₆ for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous.

Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, H⁺ or NH₄⁺, in particular an alkali metal ion such as Li⁺, Na⁺ and K⁺ or H⁺, where not all the variables M simultaneously have the meaning H⁺;
n=0;
m is an integer from 10 to 1400; and
x=1 or 2.

In certain embodiments, suitable additives may include, in particular, polyacrylic acids, polymethacrylic acids and acrylic acid-methacrylic acid copolymers, whose acid groups are at least partly neutralized, such as by preferably about 40%, and particularly preferably by about 80%. The percentage refers to the number of acid groups. Quite particularly preferred are poly(meth)acrylic acids which are present entirely in the salt form. Suitable salts include Li, Na, K, Rb, Be, Mg, Ca, Sr, Zn, and ammonium (NR₄, wherein R is either hydrogen or a carbon functional group). Poly(meth)acrylic acids may include polyacrylic acids, polymethacrylic acids, and acrylic acid-methacrylic acid copolymers. Poly(meth)acrylic acids are preferred and in particular polyacrylic acids with an average molar mass Mw of about 1,000 g/mol to 100,000 g/mol, particularly preferably 1,000 g/mol to 15,000 g/mol and quite particularly preferably 1,000 g/mol to 4,000 g/mol. The molecular weight of the poly(meth)acrylic acid polymers and copolymers is ascertained by measuring the viscosity of a 1% aqueous solution, neutralized with sodium hydroxide solution, of the polymer (Fikentscher's constant).

Also suitable are copolymers of (meth)acrylic acid, in particular copolymers which, besides (meth)acrylic acid contain ethylene, maleic acid, methyl acrylate, ethyl acrylate, butyl acrylate and/or ethylhexyl acrylate as comonomer. Copolymers are preferred which contain at least about 40% by weight and preferably at least about 80% by weight (meth)acrylic acid monomer; the percentages being based on the acid form of the monomers or polymers.

To neutralize the polyacrylic acid polymers and copolymers, alkali metal and alkaline-earth metal hydroxides such as potassium hydroxide and in particular sodium hydroxide are particularly suitable. In addition, a coating and/or additive to enhance the separator may include, for example, a metal alkoxide, wherein the metal may be, by way of example only (not intended to be limiting), Zn, Na, or Al, by way of example only, sodium ethoxide.

In some embodiments, the porous polyolefin porous membrane may include a coating on one or both sides of such layer. Such a coating may include a surfactant or other material. In some embodiments, the coating may include one or more materials described, for example, in U.S. Pat. No. 9,876,209 to Deiters, et al., which is incorporated by reference herein. Such a coating may, for example, reduce the overcharge voltage of the battery system, thereby extending battery life with less grid corrosion and preventing dry out and/or water loss.

In certain select embodiments, the membrane may be prepared by combining, by weight, about 5% to 15% polymer, in some instances, about 10% polymer (e.g., polyethylene), about 10% to 75% filler (e.g., silica), in some instances, about 30% filler, and about 10% to 85% processing oil, in some instances, about 60% processing oil. In other embodiments, the filler content is reduced, and the oil content is higher, for instance, greater than about 61%, 62%, 63%, 64%, 65%, 66%, 67%, 68%, 69% or 70% by weight. The filler:polymer ratio (by weight) may be about (or may be between about these specific ranges) such as 2:1, 2.5:1, 3:1, 3.5:1, 4.0:1. 4.5:1, 5.0:1, 5.5:1 or 6:1. The filler:polymer ratio (by weight) may be from about 1.5:1 to about 6:1, in some instances, 2:1 to 6:1, from about 2:1 to 5:1, from about 2:1 to 4:1, and in some instances, from about 2:1 to about 3:1. The amounts of the filler, the oil, and polymer are all balanced for runnability and desirable separator properties, such as electrical resistance, basis weight, puncture resistance, bending stiffness, oxidation resistance, porosity, physical strength, tortuosity, and the like.

In accordance with at least one embodiment, the porous membrane can include an UHMWPE mixed with a processing oil and precipitated silica. In accordance with at least one embodiment, the porous membrane can include an UHMWPE mixed with a processing oil, additive and precipitated silica. The mixture may also include minor amounts of other additives or agents as is common in the separator arts (e.g., surfactants, wetting agents, colorants, antistatic additives, antioxidants, and/or the like, and any combination thereof). In certain instances, the porous polymer layer may be a homogeneous mixture of about 8% to 100% by volume of polyolefin, about 0% to 40% by volume of a plasticizer and about 0% to 92% by volume of inert filler material. The preferred plasticizer is petroleum oil. Since the plasticizer is the component which is easiest to remove, by solvent extraction and drying, from the polymer-filler-plasticizer composition, it is useful in imparting porosity to the battery separator.

In certain embodiments, the porous membrane disclosed herein may contain latex and/or rubber, which may be a natural rubber, synthetic rubber, or a mixture thereof. Natural rubbers may include one or more blends of polyisoprenes, which are commercially available from a variety of suppliers. Exemplary synthetic rubbers include methyl rubber, polybutadiene, chloroprene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (EPM and EPDM) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber. The rubber may be present in the separator in an amount that is at least about 1%, 2%, 3%, 4%, 5%, 6%, 7%, 8%, 9%, or 10% by weight relative to the final separator weight (the weight of the polyolefin separator sheet or layer containing rubber and/or latex). In certain embodiments, the rubber may be present in an amount from approximately 1% to 6%, approximately 3% to 6% by weight, approximately 3% by weight, and approximately 6% by weight. The porous membrane may have a filler to polymer and rubber (filler:polymer and rubber) weight ratio of approximately 2.6:1.0. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

A porous membrane made in accordance with the present invention, is provided with a polyethylene and a filler (e.g., silica) typically has a residual oil content; in some embodiments, such residual oil content is from about 0.5% up to about 40% of the total weight of the separator membrane (in some instances, about 10-40% of the total weight of the separator membrane, and in some instances, about 20% to 40% of that total weight). In certain select embodiments herein, some to all of the residual oil content in the separator may be replaced by the addition of more of a performance enhancing additive, such as a surfactant, such as a surfactant with a hydrophilic-lipophilic balance (“HLB”) less than 6, or such as a nonionic surfactant. For example, a performance enhancing additive such as a surfactant, such as a nonionic surfactant, may have up to 0.5% all the way up to all of the amount of the residual oil content (e.g., all the way up to 20% or 30% or even 40%) of the total weight of the porous separator membrane, thereby partially or completely replacing the residual oil in the separator membrane.

In some exemplary embodiments, an exemplary separator may be made by mixing the constituent parts in an extruder. For example, about 5% to 15% by weight polymer (e.g., polyethylene), about 10% to 75% by weight filler (e.g., silica), and about 10% to 85% processing oil, and optionally about 1% to 50% by weight rubber and/or latex may be mixed in an extruder. The exemplary porous membrane may be made by passing the constituent parts through a heated extruder, passing the extrudate generated by the extruder through a die and into a nip formed by two heated presses or calender stack or rolls to form a continuous web. A substantial amount of the processing oil from the web may be extracted by use of a solvent. The web may then be dried and slit into lanes of predetermined width, and then wound onto rolls. Additionally, the presses or calender rolls may be engraved with various groove patterns to impart ribs, grooves, textured areas, embossments, and/or the like as substantially described herein. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

In addition to or as an alternative to being added to the constituent parts of the extruder, certain embodiments combine the rubber to the porous membrane after extrusion. For example, the rubber may be coated onto one or both sides, preferably on the side facing the negative electrode, with a liquid slurry having the rubber and/or latex, optionally, silica, and water, and then dried such that a film of this material is formed upon the surface of an exemplary porous membrane. For better wettability of this layer, known wetting agents may be added to the slurry for use in lead acid batteries. In certain embodiments, the slurry can also contain one or more performance enhancing additives as described herein. After drying, a porous layer and/or film forms on the surface of the separator, which adheres very well to the porous membrane and increases electrical resistance only insignificantly, if at all. After the rubber is added, it may be further compressed using either a machine press or calender stack or roll. Other possible methods to apply the rubber and/or latex are to apply a rubber and/or latex slurry by dip coat, roller coat, spray coat, or curtain coat one or more surfaces of the separator, or any combination thereof. These processes may occur before or after the processing oil has been extracted, or before or after it is slit into lanes.

A further embodiment of the present invention involves depositing rubber onto the membrane by impregnation and drying.

In certain embodiments, performance enhancing additives or agents (e.g., surfactants, wetting agents, colorants, antistatic additives, antioxidants, and/or the like, and any combination thereof) may also be mixed together with the other constituent parts within the extruder. A porous membrane according to the present disclosure may then be extruded into the shape of a sheet or web, and finished in substantially the same way as described above.

In certain embodiments, and in addition or alternative to adding into the extruder, the additive or additives may, for example, be applied to the separator porous membrane when it is finished (e.g., after extracting a bulk of the processing oil, and before or after the introduction of the rubber). According to certain preferred embodiments, the additive or a solution (e.g., an aqueous solution) of the additive is applied to one or more surfaces of the separator. This variant is suitable in particular for the application of non-thermostable additives and additives which are soluble in the solvent used for the extraction of processing oil. Particularly suitable as solvents for the additives according to the invention are low-molecular-weight alcohols, such as methanol and ethanol, as well as mixtures of these alcohols with water. The application can take place on the side facing the negative electrode, the side facing the positive electrode, or on both sides of the separator. The application may also take place during the extraction of the pore forming agent (e.g., the processing oil) while in a solvent bath. In certain select embodiments, some portion of a performance enhancing additive, such as a surfactant coating or a performance enhancing additive added to the extruder before the separator is made (or both) may combine with the antimony in the battery system and may inactivate it and/or form a compound with it and/or cause it to drop down into the mud rest of the battery and/or prevent it from depositing onto the negative electrode. The surfactant or additive may also be added to the electrolyte, the glass mat, the battery case, pasting paper, pasting mat, and/or the like, or combinations thereof.

In certain embodiments, the additive (e.g., a non-ionic surfactant, an anionic surfactant, or mixtures thereof) may be present at a density or add-on level of at least about 0.5 g/m², 1.0 g/m², 1.5 g/m², 2.0 g/m², 2.5 g/m², 3.0 g/m², 3.5 g/m², 4.0 g/m², 4.5 g/m², 5.0 g/m², 5.5 g/m², 6.0 g/m², 6.5 g/m², 7.0 g/m², 7.5 g/m², 8.0 g/m², 8.5 g/m², 9.0 g/m², 9.5 g/m² or 10.0 g/m² or even up to about 25.0 g/m². The additive may be present on the separator at a density or add-on level between about 0.5-15 g/m², 0.5-10 g/m², 1.0-10.0 g/m², 1.5-10.0 g/m², 2.0-10.0 g/m², 2.5-10.0 g/m², 3.0-10.0 g/m², 3.5-10.0 g/m², 4.0-10.0 g/m², 4.5-10.0 g/m², 5.0-10.0 g/m², 5.5-10.0 g/m², 6.0-10.0 g/m², 6.5-10.0 g/m², 7.0-10.0 g/m², 7.5-10.0 g/m², 4.5-7.5 g/m², 5.0-10.5 g/m², 5.0-11.0 g/m², 5.0-12.0 g/m², 5.0-15.0 g/m², 5.0-16.0 g/m², 5.0-17.0 g/m², 5.0-18.0 g/m², 5.0-19.0 g/m², 5.0-20.0 g/m², 5.0-21.0 g/m², 5.0-22.0 g/m², 5.0-23.0 g/m², 5.0-24.0 g/m², or 5.0-25.0 g/m².

The application may also take place by dipping the exemplary separator in the additive or a solution of the additive (solvent bath addition) and removing the solvent if necessary (e.g., by drying). In this way the application of the additive may be combined, for example, with the extraction often applied during membrane production. Other preferred methods are to spray the surface with additive, dip coat, roller coat, or curtain coat the one or more additives on the surface of separator.

In certain embodiments described herein, a reduced amount of ionic, cationic, anionic, or non-ionic surfactant is added to the inventive separator. In such instances, a desirable feature may include lowered total organic carbons and/or lowered volatile organic compounds (because of the lower amount of surfactant) may produce a desirable inventive separator according to such embodiment.

In certain embodiments, exemplary separators according to the present disclosure may be combined with another layer (laminated or otherwise), such as a fibrous layer or fibrous mat having enhanced wicking properties and/or enhanced wetting or holding of electrolyte properties. The fibrous mat may be nonwoven, woven, fleeces, mesh, net, single layered, multi-layered (where each layer may have the same, similar or different characteristics than the other layers), composed of glass fibers, or synthetic fibers, fleeces or fabrics made from synthetic fibers or mixtures with glass and synthetic fibers or paper, or a combination thereof.

In certain embodiments, the fibrous mat (laminated or otherwise) may be used as a carrier for additional materials. The additional material may include, for example, rubber and/or latex, optionally silica, water, and/or one or more performance enhancing additive, such as various additives described herein, or any combination thereof. By way of example, the additional material may be delivered in the form of a slurry that may then be coated onto one or more surfaces of the fibrous mat to form a film, or soaked and impregnated into the fibrous mat.

When the fibrous layer is present, it is preferred that the porous membrane has a larger surface area than the fibrous layers. Thus, when combining the porous membrane and the fibrous layers, the fibrous layers do not completely cover the porous layer. It is preferred that at least two opposing edge regions of the membrane layer remain uncovered to provide edges for heat sealing which facilitates the optional formation of pockets or envelopes and/or the like. Such a fibrous mat may have a thickness that is at least 100 μm, in some embodiments, at least about 200 μm, at least about 250 μm, at least about 300 μm, at least about 400 μm, at least about 500 μm, at least about 600 μm, at least about 700 μm, at least about 800 μm, at least about 900 μm, at least about 1 mm, at least about 2 mm, and so forth. The subsequent laminated separator may be cut into pieces. In certain embodiments, the fibrous mat is laminated to a ribbed surface of the porous membrane porous membrane. In certain embodiments, handling and/or assembly advantages are provided to the battery maker with the improved separator described herein, as it may be supplied in roll form and/or cut piece form. And as mentioned previously, the improved separator may be a standalone separator sheet or layer without the addition of one or more fibrous mats or the like.

If the fibrous mat is laminated to the porous membrane, they may be bonded together by adhesive, heat, ultrasonic welding, compression, and/or the like, or any combination thereof.

### Examples

Three prototype separators were created in accordance with the descriptions of exemplary embodiments of the present invention as detailed herein and tested against a control separator. The specifications of the four tested separators are described below in Table 1. The four separators were tested at 4 different pressures as a proof of concept. The test method that was employed utilized weights of 0.0 oz. (0.0 g); 8 oz. (224 g); 11 oz. (308); and 16 oz. (448 g). These weights were applied to a round plate with an area of 3.14 in², or 0.00203 m². Thus, from the applied weight and tested area, the overall applied force and pressure can be easily calculated. The forces applied were 0.0 N; 2.2 N; 3.0 N; and 4.4 N. The pressures utilized were 0.0 kPa with no force applied; 1.098 kPa with 2.2 N of applied force; 1.510 kPa with 3.0 N of applied force; and 2.196 kPa with 4.4 N of applied force. The plate utilized during testing applied a small amount of weight (due to its mass), therefore the actual applied pressure may have been a negligible amount greater than that listed.

TABLE 1
Separator Properties and Specifications

| | Separator A | | Separator B | | Separator C | | Separator D | | Control | |
|---|---|---|---|---|---|---|---|---|---|---|
| Material | Polyethylene | | Polyethylene | | Phenolic | | Phenolic | | Polyethylene | |
| Backweb | 175 | μm | 175 | μm | 175 | μm | 175 | μm | 250 | μm |
| Thickness | | | | | | | | | | |
| Positive | Solid Linear | | Solid Linear | | Solid Linear | | Solid Linear | | Solid Linear | |
| Ribs | | | | | | | | | | |
| Positive Rib | 550 | μm | 500 | μm | 600 | μm | 1.05 | mm | 750 | μm |
| Height | | | | | | | | | | |
| Positive Rib | 4 | mm | 6 | mm | 12 | mm | 12 | mm | 11 | mm |
| Spacing | | | | | | | | | | |
| Negative | Solid Linear | | Solid Linear | | Solid Linear | | Solid Linear | | Solid Linear | |
| Ribs | | | | | | | | | | |
| Negative | 550 | μm | 500 | μm | 600 | μm | 1.05 | mm | N/A | |
| Rib Height | | | | | | | | | | |
| Negative | 4 | mm | 6 | mm | 12 | mm | 12 | mm | N/A | |
| Rib Spacing | | | | | | | | | | |
| Overall Rib | 2 | mm | 3 | mm | 6 | mm | 6 | mm | 11 | mm |

| | | | | | |
|---|---|---|---|---|---|
| Spacing | | | | | |
| Mini Ribs | None | None | None | None | None |

The five samples of each of the tested separators were tested at four different pressures and an average overall thickness was calculated, as shown below in Table 2 through Table 6. The overall thickness was measured applying 0.0 kPa in pressure (i.e., no pressure). This measurement is the relaxed state thickness of the separator. All other measurements with a pressure applied to the sample represent an overall thickness in compressed states.

### Prototype A Overall Thickness (mm)

TABLE 2

| Pressure (kPa) | 0.0 | 1.098 | 1.510 | 2.196 |
|---|---|---|---|---|
| Sample #1 | 1.31 | 1.25 | 1.22 | 1.19 |
| Sample #2 | 1.25 | 1.23 | 1.24 | 1.18 |
| Sample #3 | 1.29 | 1.23 | 1.27 | 1.16 |
| Sample #4 | 1.31 | 1.21 | 1.22 | 1.20 |
| Sample #5 | 1.33 | 1.25 | 1.17 | 1.24 |
| Average | 1.30 | 1.24 | 1.22 | 1.19 |

### Prototype B Overall Thickness (mm)

TABLE 3

| Pressure (kPa) | 0.0 | 1.098 | 1.510 | 2.196 |
|---|---|---|---|---|
| Sample #1 | 1.19 | 1.05 | 0.98 | 0.98 |
| Sample #2 | 1.22 | 1.04 | 1.01 | 1.00 |
| Sample #3 | 1.15 | 0.99 | 1.03 | 0.91 |
| Sample #4 | 1.20 | 1.04 | 1.03 | 0.93 |
| Sample #5 | 1.17 | 1.03 | 0.99 | 0.96 |
| Average | 1.18 | 1.03 | 1.01 | 0.96 |

### Prototype C Overall Thickness (mm)

TABLE 4

| Pressure (kPa) | 0.0 | 1.098 | 1.510 | 2.196 |
|---|---|---|---|---|
| Sample #1 | 1.27 | 1.31 | 1.29 | 1.24 |
| Sample #2 | 1.36 | 1.17 | 1.29 | 1.10 |
| Sample #3 | 1.43 | 1.34 | 1.29 | 1.17 |
| Sample #4 | 1.45 | 1.38 | 1.09 | 1.27 |
| Sample #5 | 1.40 | 1.32 | 1.07 | 1.14 |
| Average | 1.38 | 1.30 | 1.21 | 1.18 |

### Prototype D Overall Thickness (mm)

TABLE 5

| Pressure (kPa) | 0.0 | 1.098 | 1.510 | 2.196 |
|---|---|---|---|---|
| Sample #1 | 2.21 | 2.19 | 2.00 | 2.06 |
| Sample #2 | 2.27 | 2.19 | 2.08 | 2.01 |
| Sample #3 | 2.26 | 2.09 | 2.10 | 2.09 |
| Sample #4 | 2.32 | 2.14 | 2.12 | 2.06 |
| Sample #5 | 2.21 | 2.17 | 2.10 | 1.99 |
| Average | 2.25 | 2.16 | 2.08 | 2.04 |

### Control Overall Thickness (mm)

TABLE 6

| Pressure (kPa) | 0.0 | 1.098 | 1.510 | 2.196 |
|---|---|---|---|---|
| Sample #1 | 0.98 | 0.99 | 0.97 | 0.98 |
| Sample #2 | 1.00 | 0.98 | 0.98 | 0.98 |
| Sample #3 | 1.00 | 0.99 | 0.99 | 0.97 |
| Sample #4 | 0.99 | 0.99 | 1.00 | 1.00 |
| Sample #5 | 0.98 | 0.99 | 0.98 | 0.97 |
| Average | 0.99 | 0.99 | 0.98 | 0.98 |

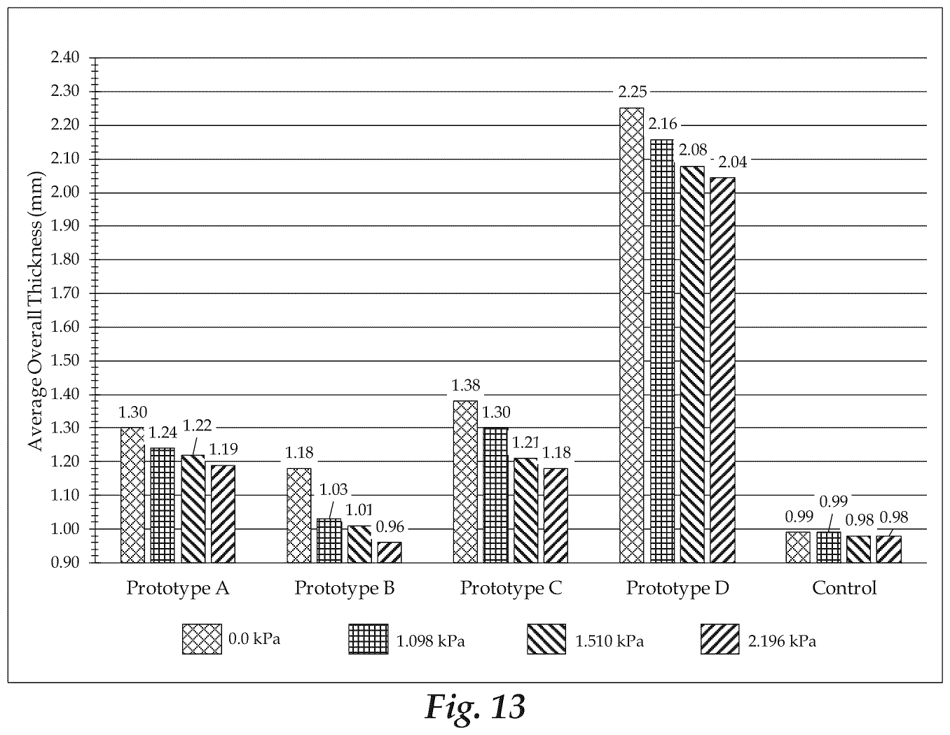

Referring now to FIG. 13, the average overall thickness of the four tested separators are depicted in a graphical format. The data depicted in FIG. 13 is found in Table 7, below.

### Average Overall Thickness (mm)

TABLE 7

| Pressure (kPa) | 0.0 | 1.098 | 1.510 | 2.196 |
|---|---|---|---|---|
| Prototype A | 1.30 | 1.24 | 1.22 | 1.19 |
| Prototype B | 1.18 | 1.03 | 1.01 | 0.96 |
| Prototype C | 1.38 | 1.30 | 1.21 | 1.18 |
| Prototype D | 2.25 | 2.16 | 2.08 | 2.04 |
| Control | 0.99 | 0.99 | 0.98 | 0.98 |

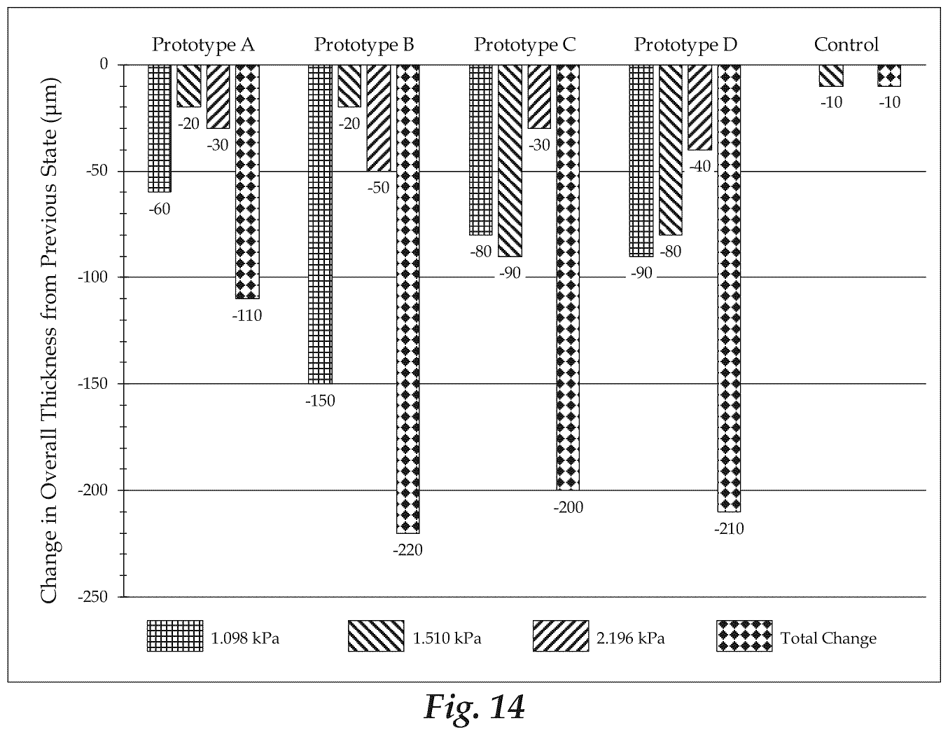

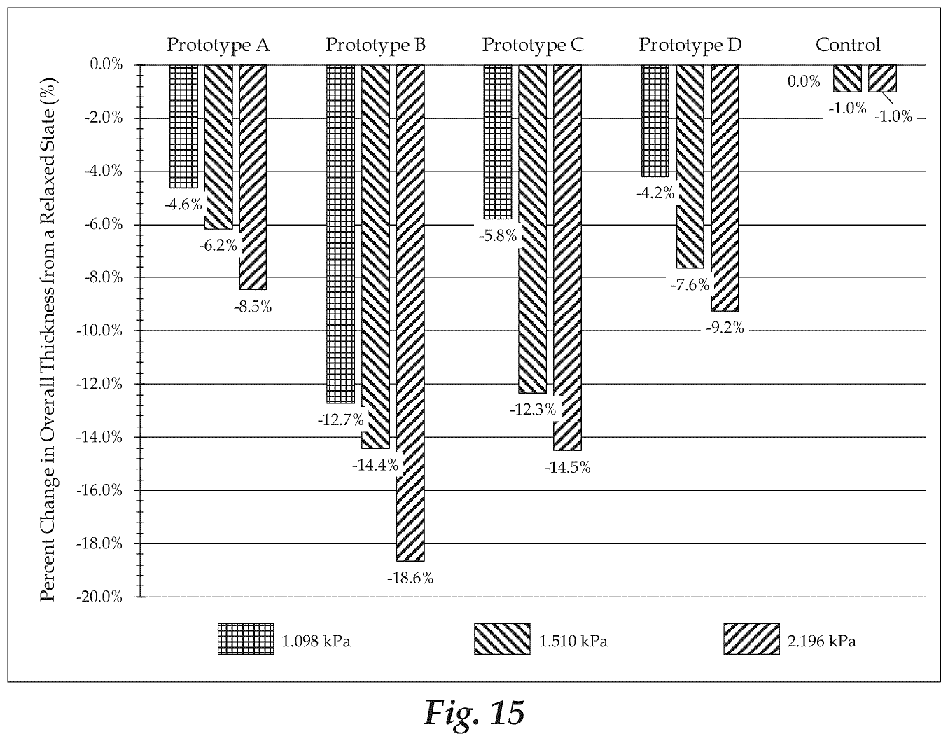

Referring now to FIG. 14 and FIG. 15, the percent change in thickness from a relaxed state of the four tested separators are depicted in a graphical format. The data depicted in FIG. 14 is found in Table 8, below, and the data of FIG. 15 is found in Table 9, below.

### Change in Thickness from a Previous State (μm)

TABLE 8

| Pressure (kPa) | 0.0 | 1.098 | 1.510 | 2.196 | Total Change |
|---|---|---|---|---|---|
| Prototype A | N/A | −60 | −20 | −30 | −110 |
| Prototype B | N/A | −150 | −20 | −50 | −220 |
| Prototype C | N/A | −80 | −90 | −30 | −200 |
| Prototype D | N/A | −90 | −80 | −40 | −210 |
| Control | N/A | 0.0 | −10 | 0.0 | −10 |

### Percent Change in Thickness from a Relaxed State (%)

TABLE 9

| Pressure (kPa) | 0.0 | 1.098 | 1.510 | 2.196 |
|---|---|---|---|---|
| Prototype A | N/A | −4.6 | −6.2 | −8.5 |
| Prototype B | N/A | −12.7 | −14.4 | −18.6 |
| Prototype C | N/A | −5.8 | −12.3 | −14.5 |
| Prototype D | N/A | −4.2 | −7.6 | −9.2 |
| Control | N/A | 0.0 | −1.0 | −1.0 |

As shown, the control separator maintains a substantially stable overall thickness throughout all applied pressures. As shown in Table 8 and Table 9, above, Prototypes A and B, the separators made of polyethylene, show a substantial change in percentage of overall thickness throughout compression. However Table 8, above, shows that the majority of change occurs during the first stage of compression. Considering the overall total change, Prototype B compressed twice as much as Prototype A (Total change: −220 μm v. −110 μm). The phenolic based separators, Prototypes C and D, the same backweb thickness and the same rib spacing. The difference being in the height of the ribs. As shown in Table 8, the two prototypes have similar compression values (Total change: −200 μm v. −210 μm), with only 10 μm difference in reduced overall thickness between the two prototypes. Of the phenolic separators (prototypes C and D), the compression seems to be more constant throughout the compression steps as compared to that of Prototype B. Table 8 also shows a doubling in compressibility (total change) when negative and positive rib spacing is increased from about 4 mm in Prototype A to about 6 mm in Prototype B. Thus, it appears a spacing greater than about 4 mm is important for achieving higher compressibility.

Further, it was found that the separators described herein exhibit excellent recovery after pressure is applied.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

For at least certain applications or batteries, the details of one or more exemplary embodiments, aspects, or objects of the present invention at least provide for battery separators having a variable overall thickness, such as an overall thickness that varies as a function of pressure applied to the separator. Other features, objects, and advantages of the present invention provide for reduced battery failure, improved battery cycle life, and/or improved performance. More particularly, there remains a need to provide a separator capable of adapting to varying electrode spacing, during at least one of the battery's production and/or in use after its manufacture.

The details of one or more exemplary embodiments, aspects, or objects, are in the detailed description and claims set forth hereinafter. Other features, objects, and advantages will be apparent from the detailed description and claims set forth hereinafter. In accordance with one or more select embodiments, aspects, or objects, the present disclosure or invention at least addresses the problems, issues, or needs enumerated herein, and in some cases provides a solution that surprisingly and unexpectedly exceeds needs and expectations.

In accordance with at least certain exemplary embodiments, objects, or aspects, the present disclosure or invention may provide novel or improved separators, cells, batteries, systems, methods of manufacture, use, and/or applications of such novel or improved separators, cells, batteries, and/or systems that overcome at least the aforementioned problems. For example, at least certain exemplary embodiments, objects, or aspects provide batteries with separators that are adaptable to electrodes with varied spacing therebetween, and by providing batteries with separators having variable thicknesses.

In accordance with at least selected exemplary embodiments, aspects, or objects, the present disclosure or invention provides a separator whose components and physical attributes and features synergistically combine to address, in surprising and unexpected ways, previously unmet needs in the lead acid battery industry with an improved battery separator. In certain preferred exemplary embodiments, the present disclosure or invention provides a battery using a separator as described herein to address, in surprising and unexpected ways, previously unmet needs in the lead acid battery industry with an improved lead acid battery separator. In certain preferred exemplary embodiments, the present disclosure or invention provides a system using a battery as described herein to address, in surprising and unexpected ways, previously unmet needs in the lead acid battery industry with an improved system utilizing an inventive lead acid battery that utilizes an inventive separator as described herein.

In accordance with at least certain embodiments, the present disclosure or invention is directed to novel or improved separators, cells, batteries, systems, and/or methods of manufacture and/or use and/or applications of such novel separators, cells, batteries, and/or systems. In accordance with at least certain embodiments, the present disclosure or invention is directed to novel or improved battery separators for: lead acid batteries; flooded lead acid batteries; enhanced flooded lead acid batteries (“EFBs”); flat-plate batteries; tubular batteries; deep-cycle batteries; batteries operating in a partial state of charge (“PSoC”); valve regulated lead acid (“VRLA”) batteries; gel batteries; absorptive glass mat (“AGM”) batteries; inverter batteries; stationary batteries; batteries used while in motion; energy storage for electricity generation, such as by steam turbine generators, such as by coal and/or gas fired power plants, and/or nuclear power plants; energy storage for electricity generation by solar power, wind power, hydro-electric power, or other alternate and/or renewable energy sources; general energy storage batteries; uninterruptible power source (“UPS”) batteries; batteries with high cold-cranking ampere (“CCA”) requirements; vehicle batteries, such as starting-lighting-ignition (“SLI”) vehicle batteries, idling-start-stop (“ISS”) vehicle batteries, marine batteries, automobile batteries, truck batteries, motorcycle batteries, all-terrain vehicle batteries, forklift batteries, golf cart (also referred to as golf cars) batteries, hybrid-electric vehicle (“HEV”) batteries, electric vehicle batteries, light electric vehicle batteries, neighborhood electric vehicle (“NEV”) batteries, e-rickshaw batteries, e-trike batteries, e-bike batteries, electric scooter batteries; and/or the like; and/or combinations thereof. In accordance with select embodiments, the present disclosure or invention is directed to battery separators for use in systems or vehicles incorporating the above-mentioned batteries. In accordance with at least certain aspects, the present disclosure or invention is directed to improved methods of making and/or using such improved separators, cells, batteries, systems, and/or the like.

In accordance with a first select embodiment of the present invention, a battery separator is provided with a porous membrane backweb having a first surface, and a second surface on an opposite side from the first surface. The separator is further provided with an array of ribs made up of a first plurality of ribs extending from the first surface, and a second plurality of ribs extending from the second surface. At least a portion of the first array of ribs are not disposed opposite of any ribs from the second plurality of ribs that are disposed on the second surface.

In accordance with some exemplary aspects of the present invention, the array of ribs may or may not be equidistantly spaced apart. In addition, either or both of the first plurality of ribs and the second plurality of ribs may or may not be equidistantly spaced apart. These rib spacings may exist in any combination.

In accordance with at least one aspect of the present invention, the array of ribs may be arranged such that one or more ribs from the first plurality of ribs alternate with one or more ribs from the second plurality of ribs across the width of the separator.

In some aspects, the separator may possess mini cross-ribs disposed on either or both of the separator surfaces. These mini cross-ribs may run in a machine direction of the separator or in a cross-machine direction of the separator between the first and second pluralities of ribs. The mini cross-ribs may have a height of approximately 25 μm to approximately 75 μm.

In select embodiments, the first plurality of ribs may be substantially parallel to one another, the second plurality of ribs may be substantially parallel to one another, and/or the first plurality of ribs may be substantially parallel to the second plurality of ribs. The first plurality of ribs and the second plurality of ribs may be substantially parallel to a machine direction of the separator.

In select preferred aspects of the present invention, the first plurality of ribs and/or the second plurality of ribs may be spaced apart at a distance between approximately 4 mm to approximately 18 mm, between approximately 5 mm to approximately 16 mm, or between approximately 6 mm and approximately 14 mm. The spacing may be 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm.

Results herein show a drastic improvement in compressibility when a spacing of approximately 6 mm is used (as compared to 4 mm), and when the spacing exceeds an amount above 12 mm or 14 mm, such as 18 mm, 20 mm, or more, the compressibility diminishes or disappears. At such higher spacing, an issue of acid displacement may appear.

In accordance with certain preferred embodiments of the present invention, the battery separator may have a relaxed state wherein the porous membrane backweb is generally planar and a different compressed state wherein the porous membrane backweb is generally warped.

In accordance with select preferred embodiments, the separator has an overall thickness defined by the distance between a plane formed by tips of the first plurality of ribs, and a plane formed by the tips of the second plurality of ribs. In select embodiments, the overall thickness in a compressed state is at least approximately 500 μm. In select embodiments, the overall thickness in a compressed state is no more than approximately 2.0 mm. In other embodiments, the overall thickness in a relaxed state is no more than approximately 3.0 mm.

In a relaxed state, the overall thickness may be measures as the sum of the porous membrane backweb thickness, the height of the first plurality of ribs, and the height of the second plurality of ribs. In such case, the overall thickness in a relaxed state is no more than approximately 3.0 mm.

In certain exemplary embodiments, the first plurality of ribs have a first rib height of approximately 200 μm to approximately 1.5 mm. In addition, the second plurality of ribs have a second rib height of approximately 200 μm to approximately 1.5 mm.

In some preferred embodiments, the first plurality of ribs have a first rib height, and said second plurality of ribs comprise a second rib height. The first height is equal to approximately 25% to approximately 400% of the second rib height.

Another aspect of the present invention provides the porous membrane backweb with a thickness of between approximately 125 μm to approximately 250 μm.

In yet another aspect of the present invention, the battery separator may have a composition that includes at least one of polymers, thermoplastic polymers, polyvinyl chlorides (“PVCs”), phenolic resins, natural or synthetic rubbers, synthetic wood pulp, lignins, glass fibers, synthetic fibers, cellulosic fibers, and/or combinations thereof. The natural or synthetic rubbers may include one or more of rubber, latex, natural rubber, synthetic rubber, cross-linked or uncross-linked natural or synthetic rubbers, cured or uncured rubbers, crumb or ground rubber, polyisoprenes, methyl rubber, polybutadiene, chloroprene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers, and/or combinations thereof.

In some aspects of the present invention, the battery separator may further possess a filler that is at least one of silica, dry finely divided silica, precipitated silica, amorphous silica, highly friable silica, alumina, talc, fish meal, fish bone meal, barium sulfate (BaSO4), carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and/or combinations thereof.

In other aspects of the present invention, the battery separator may further possess a coating that is at least one of barium sulfate (BaSO4), carbon, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (“Bucky Balls”), an aqueous carbon suspension, flake graphite, oxidized carbon, and/or combinations thereof.

In yet another exemplary aspect of the present invention, one or both of the first plurality of ribs and the second plurality of ribs are at least one of: solid ribs, discrete broken ribs, continuous ribs, discontinuous ribs, angled ribs, linear ribs, longitudinal ribs extending substantially in a machine direction of the porous membrane, lateral ribs extending substantially in a cross-machine direction of the porous membrane, transverse ribs extending substantially in a cross-machine direction of the porous membrane, cross ribs extending substantially in a cross-machine direction of the porous membrane, discrete teeth or toothed ribs, serrations, serrated ribs, battlements or battlemented ribs, curved or sinusoidal ribs, disposed in a solid or broken zig-zag-like fashion, grooves, channels, textured areas, bumps, pillars, embossments, dimples, porous, non-porous, mini ribs or cross-mini ribs, and combinations thereof. In another aspect, exemplary battery separators may possess negative cross-ribs.

In select preferred embodiments of the present invention, a lead acid battery is provided with one or more positive electrode(s), and one or more negative electrode(s), and an embodiment of a battery separator as generally described and claimed herein disposed therebetween.

In certain aspects of the present invention, the lead acid battery may be one of: a flooded lead acid battery; an enhanced flooded lead acid battery (“EFBs”); a flat-plate battery; a tubular battery; a deep-cycle battery; a battery operating in a partial state of charge (“PSoC”); a valve regulated lead acid (“VRLA”) battery; a gel battery; an absorptive glass mat (“AGM”) battery; an inverter battery; a stationary battery; a battery used while in motion; an energy storage battery for electricity generation; an energy storage battery in general; an uninterruptible power source (“UPS”) battery; a battery with high cold-cranking ampere (“CCA”) requirements; a vehicle battery, such as a starting-lighting-ignition (“SLI”) vehicle battery, an idling-start-stop (“ISS”) vehicle battery, a marine battery, an automobile battery, a truck battery, a motorcycle battery, an all-terrain vehicle battery, a forklift battery, a golf cart (also referred to as golf cars) battery, a hybrid-electric vehicle (“HEV”) battery, an electric vehicle battery, a light electric vehicle battery, a neighborhood electric vehicle (“NEV”) battery, an e-rickshaw battery, an e-trike battery, an e-bike battery, an electric scooter battery; and/or the like; and/or combinations thereof.

In certain preferred exemplary embodiments, the present invention may provide a vehicle, device, or system that utilizes a lead acid battery as generally described and claimed herein that utilizes a battery separator as generally described and claimed herein. That vehicle, device, or system may be at least one of the following: electricity generating systems, such as steam turbine generators, such as by coal and/or gas fired power plants, and/or nuclear power plants; electricity generating systems, such as by solar power, wind power, hydro-electric power, or other alternate and/or renewable energy sources; uninterruptible power sources (“UPSs”); watercraft; automobiles; trucks; motorcycles; all-terrain vehicles; forklifts; golf carts (also referred to as golf cars); hybrid-electric vehicles (“HEVs”); electric vehicles; light electric vehicles; neighborhood electric vehicles (“NEVs”); e-rickshaws; e-trikes; e-bikes; electric scooters; and/or the like; and/or combinations thereof.

In addition, a fibrous mat may be provided. The mat may be one of the following: glass fibers, synthetic fibers, silica, at least one performance enhancing additive, latex, natural rubber, synthetic rubber, and combinations thereof, and may be nonwoven, woven, mesh, fleece, net, and combinations thereof.

Furthermore, the battery separator may be provided as a cut-piece, a leaf, a pocket, a sleeve, a wrap, an envelope, and a hybrid envelope with openings at the bottom.

The first plurality of ribs may further be provided so as to enhance acid mixing in a battery, particularly during movement of the battery. The separator may be disposed such that the first and second surfaces are parallel to a start and stop motion of the battery. The separator may be provided with a mat adjacent to the positive electrode, the negative electrode, or the separator. The mat may be at least partially made of glass fibers, synthetic fibers, silica, at least one performance enhancing additive, latex, natural rubber, synthetic rubber, and any combination thereof. The mat may be nonwoven, woven, mesh, fleece, net, and combinations thereof.

In certain embodiments, the battery may operate at a depth of discharge of between approximately 1% and approximately 99%.

In accordance with at least selected exemplary embodiments, aspects, or objects, the present invention solves, meets, and/or overcomes at least the problems, needs, and/or issues, which have heretofore been unsolved, unmet, and/or not addressed by the current state of the art. In accordance with at least certain objects, the present invention provides an improved separator, an improved battery utilizing the improved separator, and/or an improved system using the improved battery that overcome, and in some cases surprisingly and unexpectedly overcome, at least the aforementioned problems. The compositions and methods of the appended claims are not limited in scope by the specific compositions and methods described herein, which are intended as illustrations of a few aspects of the claims. Any composition(s) and/or method(s) that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches. Unless defined otherwise, all technical and scientific terms used herein have the same meanings as commonly understood by one of skill in the art to which the disclosed invention belongs. Publications cited herein and the materials for which they are cited are specifically incorporated by reference.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Additionally, the invention illustratively disclosed herein may be suitably practiced in the absence of any element that is not specifically disclosed herein.

1. A battery separator comprising:
a porous membrane backweb comprising a first surface, and a second surface on an opposite side from said first surface;
at least one array of ribs comprising a first plurality of ribs extending from said first surface, and a second plurality of ribs extending from said second surface;
wherein at least a portion of said first plurality of ribs are not disposed opposite of any ribs from said second plurality of ribs that are disposed on said second surface.

2. The battery separator of claim 1, wherein said array of ribs are equidistantly spaced apart.

3. The battery separator of claim 1, wherein said array of ribs are not equidistantly spaced apart.

4. The battery separator of claim 1, wherein said first plurality of ribs are equidistantly spaced apart.

5. The battery separator of claim 4, wherein said second plurality of ribs are not equidistantly spaced apart.

6. (canceled)

7. (canceled)

8. (canceled)

9. The battery separator of claim 1, wherein said first plurality of ribs are spaced apart at a first distance; and said second plurality of ribs are spaced apart at a second distance.

10. The battery separator of claim 9, wherein said first distance is not equal to said second distance.

11. The battery separator of claim 10 wherein said first distance is equal to said second distance.

12. The battery separator of claim 1, wherein said array of ribs comprise a set of one or more ribs of said first plurality of ribs alternating with one or more ribs of said second plurality of ribs.

13. The battery separator of claim 1, further comprising mini cross-ribs disposed on said first surface, said second surface, or both of said first surface and said second surface, wherein said mini cross-ribs have a height between 25 microns to 75 microns.

14. (canceled)

15. The battery separator of claim 1, wherein each of said first plurality of ribs are substantially parallel to one another.

16. The battery separator of claim 1, wherein each of said second plurality of ribs are substantially parallel to one another.

17. The battery separator of claim 1, wherein said first plurality of ribs is substantially parallel to said second plurality of ribs.

18. The battery separator of claim 17, wherein said first plurality of ribs is substantially parallel to a separator machine direction.

19. The battery separator of claim 1, wherein at least one of said first plurality of ribs and said second plurality of ribs is spaced apart at a distance between approximately 4 mm to approximately 18 mm, between approximately 5 mm to approximately 16 mm, or between approximately 6 mm and approximately 14 mm.

20. (canceled)

21. The battery separator of claim 1, further comprising a relaxed state wherein said porous membrane backweb is generally planar and a different compressed state wherein said porous membrane backweb is generally warped.

22. The battery separator of claim 21, further comprising:
a first plane formed by tips of said first plurality of ribs;
a second plane formed by tips of said second plurality of ribs; and
an overall thickness in said compressed state being the distance between said first plane and said second plane that that is at least approximately 500 μm, and no more than 2.0 mm.

23. (canceled)

24. The battery separator of claim 21, further comprising:
a first plane formed by tips of said first plurality of ribs;
a second plane formed by tips of said second plurality of ribs; and
an overall thickness in said relaxed state being the distance between said first plane and said second plane that is no more than approximately 3.0 mm.

25. (canceled)

26. The battery separator of claim 1, wherein at least one of said first plurality of ribs and said second plurality of ribs comprise a first rib height of between approximately 200 μm to approximately 1.5 mm.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. A compressible battery separator provided with at least a 12% Change in Thickness from a Relaxed State capability.
